(19) United States
(12) Patent Application Publication
(10) Pub. No.: US 2026/0278953 A1
(43) Pub. Date: Sep. 17, 2026

(54) SYSTEM

(71) Applicant: SoftBank Group Corp., Tokyo (JP)

(72) Inventor: Kazuma TAKEHARA, Tokyo (JP)

(73) Assignee: SoftBank Group Corp., Tokyo (JP)

(21) Appl. No.: 19/550,401

(22) Filed: Feb. 26, 2026

Related U.S. Application Data
(60) Provisional application No. 63/771,982, filed on Mar. 14, 2025.

(51) Int. Cl. G06T 19/00; H04W 4/02; H04W 4/90

(52) U.S. Cl. CPC G06T 19/006; H04W 4/025; H04W 4/90

(57) ABSTRACT

A system includes a processor that is configured to receive, as user information, at least one of a postal code and an address, and information regarding an age of a user, a family structure of the user, and individual needs, acquire regional information including seismic intensity and a damage situation of a target region based on the postal code or the address, evaluate a degree of danger representing a risk level of a residence of the user based on the regional information, provide action guidance including specific actions to be taken by the user according to the evaluated degree of danger, display an optimal evacuation route from a current location of the user by using photographs and augmented reality technology, provide guidance on places where relief distributions are being carried out, and provide guidance on places where communication is relatively easy.

### CROSS-REFERENCE TO RELATED APPLICATION

This application claims the benefit of U.S. Provisional Application No. 63/771,982, filed on Mar. 14, 2025, pursuant to 35 U.S.C. § 119 (e), the entire contents of which are incorporated herein by reference.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In large-scale disasters such as earthquakes, users often cannot promptly obtain individualized and reliable information necessary for making critical decisions regarding evacuation, safety measures, and acquisition of essential supplies. Conventional disaster information systems generally provide uniform, region-wide information and do not sufficiently take into account a user's specific profile, including age, family structure, and individual needs, such as the presence of infants, elderly persons, or persons requiring special support. As a result, users may not receive appropriate evacuation recommendations or may experience delays in taking necessary actions.

Furthermore, conventional systems frequently lack integrated functions that combine personalized risk assessment with concrete action guidance, real-time evacuation route presentation, and guidance to relief distribution places and communication-conducive locations. In many cases, disaster information is fragmented across different services, which forces the user to manually gather and interpret information from multiple sources, thereby increasing cognitive load and response time under stress.

In addition, existing navigation solutions in disaster contexts often present routes only as simple two-dimensional maps, which may be difficult to understand quickly in complex or damaged environments. There is also insufficient functionality for dynamically considering the actual communication environment and lifeline availability in the user's surroundings when providing guidance.

Accordingly, there is a need for a disaster information providing system that can, based on user information including postal code or address, age, family structure, and other individual needs, acquire regional disaster information, evaluate the degree of danger at the user's residence or current location, and provide concrete and intuitive action guidance. There is a further need to display an optimal evacuation route by using photographs and augmented reality technology, and to provide integrated guidance regarding currently operating distribution places and locations where communication is relatively easy, thereby enabling the user to respond rapidly and appropriately in a disaster situation.

### SUMMARY

In order to solve the above-described problems, the present invention provides a system comprising a processor, wherein the processor is configured to perform a series of coordinated functions for disaster information provision based on both user-specific information and regional disaster information.

The processor is configured to receive, as user information, at least one of a postal code and an address, and further receive information regarding an age of a user, a family structure of the user, and other individual needs. By obtaining such detailed user information, the processor can identify vulnerable households, such as those including elderly persons or infants, and can consider special support requirements when generating guidance.

The processor is configured to acquire, as regional information, a seismic intensity and a damage situation of a target region based on the postal code or the address included in the user information. In one embodiment, the processor acquires seismic intensity information by using an application programming interface of at least one of a meteorological agency and an earthquake information providing service, and collects real-time data from at least one of a local government and a news media to grasp the damage situation. The processor thereby obtains up-to-date and region-specific disaster information.

The processor is configured to evaluate, as a degree of danger, a risk level of a residence of the user based on the regional information. In particular, the processor is configured to determine that a risk of building collapse or fire is high when the seismic intensity is 6 or greater, and to recommend immediate evacuation as part of the danger evaluation. The processor thus quantifies the degree of danger in accordance with predetermined criteria and the user's profile.

The processor is configured to provide, as action guidance, specific actions to be taken by the user according to the evaluated degree of danger. The processor provides instructions regarding securing lifelines, and determines a necessity of evacuation by taking into account the family structure of the user and the special needs included in the user information. The processor thereby generates individualized and concrete guidance suitable for the user's circumstances.

The processor is configured to display, as an evacuation route, an optimal evacuation route from a current location of the user by using photographs and augmented reality technology. The processor overlays the evacuation route on a real-world scene captured by a camera of a smartphone and displays the overlaid evacuation route so that the user can intuitively understand the evacuation route. The processor can thus guide the user along a safe path even in complex environments or when usual landmarks are damaged.

The processor is further configured to provide, as distribution place guidance, information on places where relief distributions are currently being carried out. The processor lists up distribution sites nearest to a position of the user based on at least one of an official website of a local government and information from support organizations, and provides detailed information including an address of each distribution site, types of distributed goods, and distribution times. The processor thereby enables the user to efficiently obtain necessary supplies such as water, food, and blankets.

Additionally, the processor is configured to provide, as communication place guidance, information on places where communication is relatively easy. The processor identifies locations of base stations and communication statuses based on information from communication carriers, and guides the user to a place where communication is most stable from the current location of the user. As a result, the user can secure a location suitable for contacting family members or emergency services even when communication is partially disrupted.

By performing these functions in an integrated manner, the system according to the present invention makes it possible to provide personalized risk evaluation, concrete action guidance, intuitive evacuation route display using augmented reality, and guidance to distribution places and communication-conducive locations, thereby enabling the user to respond quickly and appropriately in a disaster situation.

The term “user information” refers to information related to an individual user, including at least one of a postal code and an address, and further including information such as an age of the user, a family structure of the user, and other individual needs including special support requirements.

The term “postal code” refers to a code assigned to a geographic area by a postal service, which can be used to identify a region associated with a user's residence or current location.

The term “address” refers to a textual representation of a location, such as a street address, building name, or similar descriptive information, that specifies where a user resides or is currently located.

The term “age of a user” refers to numerical information indicating how many years the user has lived, which can be used to classify the user into categories such as child, adult, or elderly.

The term “family structure” refers to information indicating members of a user's household, including, for example, a number of family members, relationships among family members, ages of family members, and a presence or absence of members requiring special consideration.

The term “individual needs” refers to personal conditions or requirements of the user or members of the user's household, such as disabilities, chronic illnesses, mobility limitations, or other factors that may require special support during a disaster.

The term “regional information” refers to information describing a disaster situation in a geographic region associated with the user, including at least seismic intensity and a damage situation of the target region.

The term “seismic intensity” refers to a quantitative or qualitative measure of the strength of ground shaking at a specific location during an earthquake, typically represented by a scale indicating the severity of shaking.

The term “damage situation” refers to information indicating a degree and type of damage caused by a disaster in a target region, including, for example, building damage, infrastructure failure, fires, road blockages, and other harmful effects.

The term “degree of danger” refers to an evaluation result that expresses a risk level of the user's residence or current location based on regional information and optionally on user information, and that is used to determine whether evacuation or other protective actions are recommended.

The term “risk level” refers to a classification, such as low, medium, high, or very high, that expresses a relative severity of danger to the user in a disaster situation.

The term “action guidance” refers to information that indicates specific actions to be taken by the user in a disaster situation, including instructions related to evacuation, sheltering, securing lifelines, and responding to the evaluated degree of danger.

The term “evacuation route” refers to a path from a current location of the user to a destination considered safe, such as an evacuation shelter or assembly point, including waypoints, directions, and related navigation information.

The term “photographs” refers to still images that represent real-world scenes, captured by a camera of a terminal device or pre-stored, and used for visually presenting an evacuation route or related guidance.

The term “augmented reality technology” refers to technology that overlays computer-generated information, such as arrows or route lines, on a live or recorded image of the real-world environment, so that the user can view digital content combined with real-world scenes.

The term “distribution place guidance” refers to information provided to the user regarding locations at which relief distributions, such as water, food, or supplies, are currently being carried out, including location details and operational conditions of such places.

The term “distribution site” refers to a place where relief goods or services, such as drinking water, food, blankets, or other necessities, are distributed to disaster victims.

The term “communication place guidance” refers to information provided to the user regarding places where communication, such as voice calls or data communication, is relatively easy or more stable compared to surrounding areas.

The term “place where communication is relatively easy” refers to a location at which communication quality, such as signal strength or network stability, is expected to be higher or more reliable, based on information such as base-station locations and network status.

The term “base station” refers to a communication infrastructure element, such as a cellular tower or similar facility, that provides wireless communication coverage to mobile devices within a service area.

The term “local government” refers to a municipal, regional, or similar governmental entity that manages administrative functions and may provide official disaster-related information, including information on damage, shelters, and distribution sites.

The term “support organization” refers to a public or private entity, such as a relief agency, non-governmental organization, or volunteer group, that conducts support activities including distribution of supplies during a disaster.

The term “communication carrier” refers to a company or service provider that operates communication networks, such as mobile phone networks or data networks, and that can provide information on base-station locations and communication status.

The term “lifelines” refers to essential infrastructure and services necessary for daily life and survival, including, for example, water supply, electricity, gas, and basic communication services.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

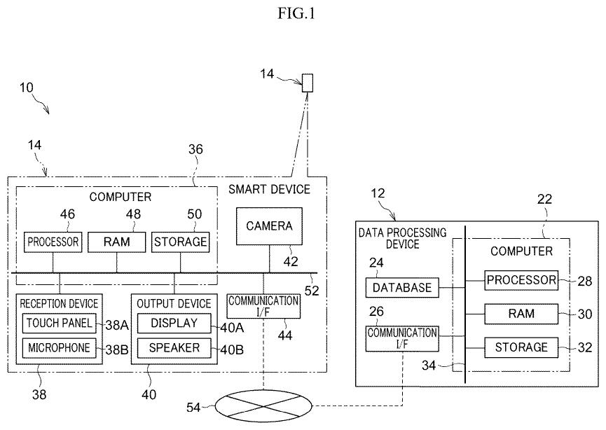

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

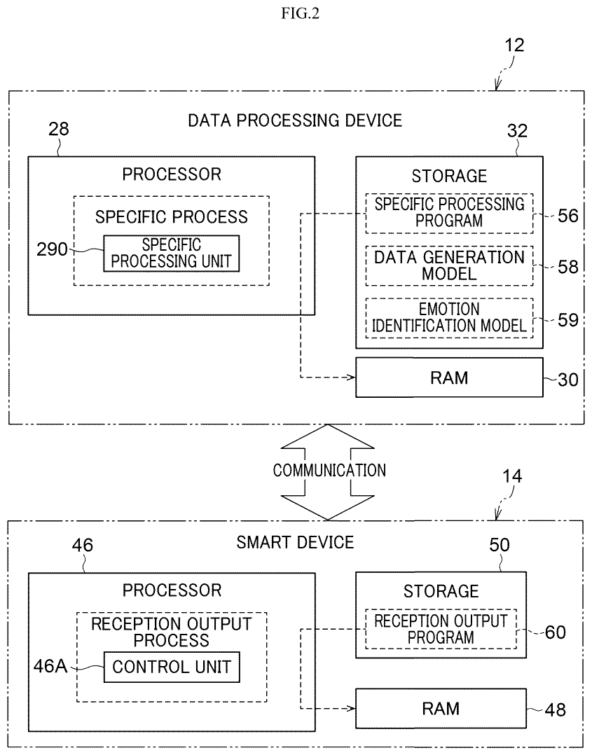

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional disaster information systems generally rely on static rule sets and pre-defined content templates to deliver alerts and guidance to end users. Such systems typically separate acquisition of regional disaster information, risk evaluation, and user notification into loosely coupled components that operate on coarse-grained data. As a result, these systems often (i) fail to adapt guidance to detailed user attributes such as age, household composition, or special support needs, (ii) do not continuously re-evaluate risk as heterogeneous, time-series environmental data changes, and (iii) cannot efficiently present complex, multi-source information to resource-constrained user terminals in a form that is both machine-optimized and human-intuitive, for example, in augmented reality overlays.

From a computer-technology standpoint, existing architectures exhibit several technical deficiencies. First, server-side processing pipelines typically do not unify time-series environmental information, user attribute information, and spatial information in a manner that supports low-latency, per-user risk index computation and guideline generation. Instead, they either over-simplify risk calculations or require manual operator intervention, which leads to processing bottlenecks and inconsistent machine behavior. Second, user terminals generally render map displays and camera images independently, without integrated control logic on the server that coordinates evacuation routes, relief distribution site guidance, and communication service site guidance under a single, dynamically updated instruction set. This limits the system's ability to compute and transmit optimized display information that leverages positioning functions, imaging functions, and augmented reality functions as a coherent machine process. Furthermore, recent use of generative AI models in disaster contexts has been largely ad hoc, with no systematic mechanism for the server to construct prompt sentences based on machine-readable context, invoke the generative AI model as a controlled subsystem, and then automatically filter and integrate the resulting candidate content according to safety and reliability rules. Without such mechanisms, incorporating generative AI into a disaster support workflow risks producing non-deterministic or unsafe outputs, and increases the computational and engineering burden required to validate responses at scale.

Accordingly, there is a need for an improved computer-implemented disaster information system in which a processor centrally performs: (i) structured acquisition and time-series storage of environmental information from multiple external sources, (ii) computation and continuous updating of a user-specific risk index using both environmental and user attribute information, (iii) generation and refinement of action guideline information with assistance from a generative AI model under explicit safety and reliability constraints, and (iv) construction of unified display information for user terminals that supports coordinated map and augmented reality presentation of evacuation routes, relief distribution sites, and communication service sites. Such a system should improve the technical functioning of the server and terminal by optimizing data flows, reducing latency, ensuring deterministic control over generative AI outputs, and enabling the terminals to perform context-aware rendering with fewer local computations and simplified application logic.

The specific processing by the specific processing unit 290 of the data processing device 12 in Example 1 is realized by the following means.

The present invention provides a server comprising a processor and a memory storing instructions, wherein the instructions, when executed by the processor, cause the processor to receive user attribute information from a user terminal and store the user attribute information as electronic data; to acquire environmental information relating to a disaster from one or more external information providing apparatuses on the basis of location reference information, and to store the acquired environmental information as time-series data; to calculate a risk index for a residential area on the basis of the environmental information and the user attribute information, and to update the risk index in response to changes in at least one of usage state information and the environmental information; to generate action guideline information according to the risk index and the user attribute information; to generate a prompt sentence describing an action guideline generation process in the disaster, input the prompt sentence to a generative AI model, obtain from the generative AI model a candidate of the action guideline information, verify the candidate of the action guideline information based on predetermined safety and reliability rules, and select verified action guideline information that conforms to the rules; to construct display information including the verified action guideline information, augmented reality display information, and map display information; to collect and integrate relief distribution site information and communication service providing site information from one or more external information sources, and calculate, for each site, a distance, a required time, and at least one of an assumed congestion level, a type of supply, and a communication quality with respect to a current position of the user terminal; and to transmit the display information to the user terminal for controlling the user terminal to acquire the current position and a real-space image by using a positioning function and an imaging function and to superimpose and display at least one of an evacuation route, a relief distribution site guidance, and a communication service providing site guidance on the real-space image. This enables an integrated, computer-implemented disaster support architecture in which the server efficiently orchestrates multi-source time-series data processing, personalized risk index computation, and controlled generative AI-assisted guideline generation, and provides the user terminal with optimized, context-aware display information for map and augmented reality rendering, thereby improving system responsiveness, safety of generated content, and the technical performance of both server-side and terminal-side components.

The term “user attribute information” refers to electronic information indicative of characteristics of a user, including at least age information, household composition information, and information indicating whether the user requires special support in a disaster, and optionally further including information about location preferences, mobility constraints, and health-related needs.

The term “location reference information” refers to electronic information used to identify a geographic area or position, including at least one of a postal code, an address, or geographic coordinates, and which is used by a processor to associate a user or a device with environmental information and site information.

The term “environmental information” refers to electronic information representing a state of a physical environment related to a disaster, including at least vibration intensity information, damage occurrence frequency information, past disaster history information, lifeline status information, road condition information, and communication quality information, which may be obtained from one or more external information providing apparatuses.

The term “external information providing apparatus” refers to an information processing apparatus or system, such as a server or data service, that provides environmental information, relief distribution site information, communication service providing site information, or other disaster-related information through a communication network.

The term “time-series data” refers to electronic data that is stored together with temporal identifiers, such as timestamps, and that represents changes in environmental information, site information, or usage state information over time.

The term “risk index” refers to an electronically computed metric or set of metrics indicative of a degree of disaster-related risk for a user or a residential area, the metric being derived at least from environmental information and user attribute information and being expressible as a numerical score, a categorical level, or a combination thereof.

The term “residential area” refers to a geographic region or zone that includes at least one location at which a user resides or is presumed to reside, and which is identified by location reference information for the purpose of risk index calculation.

The term “usage state information” refers to electronic information representing one or more aspects of how users and terminals interact with a system, including at least access history, request frequency, location change events, user confirmations, and responses to action guideline information, which can be used to update risk assessment or guideline content.

The term “action guideline information” refers to electronic information indicating one or more recommended actions or procedures for a user to perform in relation to a disaster event, including at least evacuation instructions, safety precautions, lifeline securing steps, and guidance for using relief distribution sites and communication service providing sites.

The term “display information” refers to electronic information generated for presentation on a user terminal, including at least action guideline information, augmented reality display information, and map display information, and optionally including textual, graphical, and symbolic elements formatted for rendering by a display apparatus.

The term “augmented reality display information” refers to electronic information suitable for use in superimposing virtual objects, such as evacuation routes, symbols, and annotations, onto a real-space image captured by an imaging function of a user terminal, in alignment with a physical environment as determined by positioning and orientation information.

The term “map display information” refers to electronic information for rendering a planar or three-dimensional geographic representation, including at least route geometry, point-of-interest positions, and associated metadata, for display on a user terminal.

The term “user terminal” refers to an information processing apparatus operated by a user, including at least a portable terminal device having a processor, a memory, a positioning function, an imaging function, a display apparatus, and a communication interface, such as a smartphone or a tablet.

The term “positioning function” refers to hardware and software functions of a user terminal that enable determination of a geographic position of the user terminal, using at least one of satellite positioning signals, network-based positioning, and sensor-based positioning.

The term “imaging function” refers to hardware and software functions of a user terminal that enable capturing of real-space images or video, including at least one image sensor and associated image processing components.

The term “real-space image” refers to an image or video frame representing a physical environment captured by an imaging function of a user terminal, prior to or after superimposition of virtual content.

The term “evacuation route” refers to a path or course, represented as electronic data including at least a sequence of positions or segments, that leads from a current position or a starting position of a user to a destination such as a shelter, safe area, relief distribution site, or communication service providing site.

The term “relief distribution site information” refers to electronic information regarding sites that distribute supplies in a disaster, including at least geographic positions, addresses, types of supplies, distribution times, and optionally capacity or congestion-related information.

The term “relief distribution site” refers to a physical facility or place at which supplies such as water, food, clothing, or medical items are distributed to users during or after a disaster.

The term “communication service providing site information” refers to electronic information regarding locations where a communication quality is relatively good or stable, including at least geographic positions, an indication of available communication services, and quality-related metrics.

The term “communication service providing site” refers to a physical location at which communication with a communication network is available with a relatively good quality, as determined based on communication base equipment position information and communication quality information.

The term “communication base equipment position information” refers to electronic information indicating positions of communication infrastructure elements, such as base stations or access points, which support wireless or wired communication services.

The term “communication quality information” refers to electronic information indicating one or more metrics of communication performance, including at least signal strength, data throughput, latency, packet loss, or outage status for a communication service.

The term “generative AI model” refers to an information processing model implemented in hardware and software that, in response to an input prompt sentence, outputs generated information such as text, instructions, or recommendations, using machine-learned parameters trained on data, and is capable of generating content not explicitly stored as fixed templates.

The term “prompt sentence” refers to a sequence of electronic text or tokens provided as input to a generative AI model, the sequence describing a context, a task, constraints, or an expected output format, and used by the generative AI model to generate a candidate of action guideline information or system optimization information.

The term “candidate of the action guideline information” refers to one or more proposed instances of action guideline information output by the generative AI model in response to a prompt sentence, prior to verification or filtering by safety or reliability rules.

The term “safety rule” refers to an electronically defined condition or set of conditions that specifies whether a piece of action guideline information is considered safe, based on criteria such as avoidance of hazardous behavior, compliance with known disaster response protocols, and exclusion of instructions that could cause harm.

The term “reliability rule” refers to an electronically defined condition or set of conditions that specifies whether a piece of action guideline information is considered reliable, based on criteria such as consistency with trusted environmental information sources, logical coherence, and absence of contradictions with system knowledge.

The term “verified action guideline information” refers to action guideline information that has been derived from a candidate generated by a generative AI model and has been checked and approved according to at least one safety rule and at least one reliability rule, including information that has been automatically corrected or partially removed to comply with such rules.

The term “priority order” refers to an order of presentation or selection determined by a processor based on one or more evaluation metrics, such as distance, required time, assumed congestion level, type of supply, user attribute information, or communication quality, where items with a higher priority are presented earlier or more prominently.

The term “context information” refers to electronic information that collectively describes a current situation of a user and an environment, including at least the risk index, the user attribute information, and the environmental information, and that is used to construct a prompt sentence or to control generation and presentation of action guideline information.

In one embodiment, a server and a terminal cooperate to implement the system according to the claims. The server includes at least one processor, a main memory, a non-volatile storage device, and a network interface, and executes server-side software on an operating system such as a general-purpose server operating system. The terminal includes a processor, a memory, a display apparatus, a positioning sensor, an imaging sensor, and a wireless communication interface, and executes a mobile operating system such as a smartphone operating system.

The server stores program instructions for performing user attribute management, environmental information acquisition, time-series data storage, risk index computation, guideline generation, generative AI model control, safety/reliability verification, site information integration, and display information generation. The terminal stores program instructions for user input, communication with the server, map rendering, augmented reality rendering, and user interface control.

The server uses a database management system such as a relational database system to store user attribute information, environmental information, site information, risk index values, and action guideline information. The server uses a data schema in which user attribute information is stored in a user table, with fields for age range, household size, presence of elderly persons, presence of infants, special support needs, and a location reference. The server uses separate tables for environmental information, including vibration measurements, damage reports, lifeline status, road closure information, and communication quality measurements, indexed by time and geographic region. The server uses additional tables for relief distribution sites and communication service providing sites, including coordinates, opening times, types of supplies, and quality metrics.

The server receives user attribute information from the terminal as structured data over a secure transport protocol. The terminal displays entry fields for postal code or address, age, household composition, and special needs using native user interface components. The user operates the terminal to input the information by touch or voice, and the terminal validates and transmits the data to the server. The server parses the transmitted data, converts categorical values into indexed codes, and stores them in the database for later computation.

The server acquires environmental information related to disasters by issuing periodic and on-demand requests to external information providing apparatuses via a wide-area network. The server sends structured queries specifying geographic areas identified by location reference information. The external apparatuses return structured responses containing seismic intensity, estimated damage levels, lifeline outage information, and other sensor-derived metrics. The server transforms the responses into internal normalized records, assigns precise timestamps, and stores them as time-series data. The server uses indexing on time and geographic region to allow efficient retrieval of recent and historical environmental information for a particular user or region.

The server computes a risk index for each user or region by applying numerical algorithms that combine environmental information and user attribute information. In one embodiment, the server uses a multi-stage computation. The server first computes a base regional risk value using a function of recent maximum vibration intensity, cumulative damage reports, and frequency of events in a given time window. The server may apply a weighted moving average, where recent measurements receive higher weight than older measurements. The server then adjusts the regional risk by applying correction factors based on user attribute information, such as increasing the risk for users with mobility impairments or households with infants. The server stores the resulting risk index as a normalized value, such as a floating-point value between 0 and 1, and optionally maps it to discrete levels such as “Low,” “Medium,” “High,” and “Critical” for interpretability.

The server generates action guideline information based on the computed risk index and user attribute information. In one embodiment, the server uses a rule-based engine that contains conditional rules defined over the risk index, environmental information, and user attributes. For example, the server applies a rule that if the risk index exceeds a threshold and the user has a mobility impairment, then the server generates guidelines that emphasize early evacuation and selection of barrier-free routes. The server encodes these rules as data structures that associate conditions with textual guideline templates. By doing so, the server can generate guideline information deterministically even without a generative AI model, thereby maintaining a baseline of safety and predictability.

The server further refines the action guideline information by interacting with a generative AI model hosted on the same server or on a connected computing node. The generative AI model is implemented as a neural network including an embedding layer, multiple transformer or recurrent layers, and an output projection layer. The server pre-trains or fine-tunes the model on corpora of disaster-related instructions and technical manuals using supervised learning. During training, the server uses a loss function such as cross-entropy between predicted tokens and reference tokens, and uses gradient-based optimization such as stochastic gradient descent with adaptive learning rates to update the model weights. The server may apply regularization and data augmentation, for example by paraphrasing guidelines or injecting synthetic examples of environmental contexts, to improve the generalization performance of the model.

The server constructs a prompt sentence that encodes the current context as structured text. The server includes the user's age category, household composition, special support needs, recent seismic intensity, estimated structural damage, and the current risk index value in the prompt sentence, together with explicit instructions about the desired style and content. For example, the server may form a prompt sentence such as:
“A 75-year-old user lives in an area where the latest seismic intensity is 7, and there is a high risk of building collapse and fire. The household consists of two elderly persons and no children. Please generate clear, step-by-step evacuation and safety guidelines suitable for elderly users, including instructions about when to evacuate, how to turn off gas and electricity, how to prepare necessary medicine, and how to avoid dangerous areas while moving to a shelter.”

In another example, the server may generate a prompt sentence such as:
“Given a disaster support system that provides evacuation guidance, distribution site information, and communication spot recommendations, please propose an algorithm that dynamically adjusts evacuation routes using real-time seismic and road closure data, and explain how to integrate this algorithm into a mobile application in short, technical language.”

The server sends the prompt sentence to the generative AI model and receives a candidate of the action guideline information as generated text. The server does not directly expose the raw output to the user. Instead, the server applies a verification process based on predetermined safety rules and reliability rules. The safety rules are defined as machine-readable conditions, such as forbidding instructions that conflict with known disaster protocols or that suggest dangerous behavior, for example entering structurally compromised buildings. The reliability rules require consistency between generated statements and environmental information stored in the database, such as region-specific lifeline status or shelter availability. The server implements the verification as a combination of pattern matching, constraint checking, and cross-references to a curated knowledge base. The server identifies segments of generated text that violate any rule and either removes or corrects them using replacement templates.

The server merges the verified content from the generative AI model with the deterministic rule-based guideline information. The server may assign weights or priorities to each source, preferring conservative rule-based instructions for safety-critical items while allowing the generative AI output to augment the level of detail, such as including explanations or alternative safe options. This hybrid approach improves completeness and user comprehension while preserving predictable system control. The server stores the final action guideline information as display information, tagged with the risk index, timestamp, and version identifiers.

The server collects relief distribution site information from external information sources by periodically requesting updated lists of sites, their coordinates, types of supplies, opening times, and capacity indicators. The server normalizes these records and stores them in a spatially indexed table. The server similarly collects communication service providing site information, including positions of communication base equipment and measured or reported communication quality metrics. The server uses spatial queries to compute distances and estimated travel times from the current user position to each site. The server also computes an assumed congestion level by combining capacity indicators with historical usage patterns stored as time-series data.

The server generates display information that includes positions and attributes of relief distribution sites and communication service providing sites, together with recommended priorities. The server encodes route geometry as polylines and stores them in a route data structure that can be interpreted by the terminal. The server may pre-compute certain route segments or route candidates on the server side, thereby reducing computation load on the terminal and lowering communication overhead when multiple users request similar routes.

The terminal receives the display information from the server and renders it using a map engine and an augmented reality engine. The terminal uses a positioning function based on satellite signals, network signals, and inertial sensors to determine a current position and orientation. The terminal uses an imaging function to capture a real-space image via a camera. The terminal overlays the evacuation route, relief distribution sites, and communication service providing sites onto the real-space image by projecting the route geometry and site positions into the camera coordinate system. The terminal updates the overlay in real time as the user moves, in accordance with updated position information. This direct control of positioning and imaging hardware by the terminal, based on server-provided display information, ties the abstract computations on the server to concrete device-level behavior in the real world.

The server and the terminal cooperate to achieve technical improvements over conventional systems. The server centralizes the combination of time-series environmental information, user attribute information, and spatial information, thereby enabling faster and more accurate risk index computation. Because the server maintains indexed time-series data and pre-computed metrics, the server can respond to user queries with low latency, reducing the need for repeated heavy computation on each terminal. The use of a structured database schema and spatial indexing improves data management and query efficiency, which allows the system to scale to many users and large geographic areas without significant performance degradation.

The server's control of the generative AI model through prompt sentences and safety/reliability verification improves the technical behavior of the overall computing system. Rather than simply automating human drafting of text, the server uses a constrained input-output pattern where the model acts as a parameterized function within a larger program. The server's verification layer enforces computable rules that reduce errors, remove inconsistent content, and align outputs with sensor-derived environmental data. This architecture avoids uncontrolled, non-deterministic behavior and instead integrates the generative AI model as a component in a deterministic pipeline that improves coverage and adaptability of action guidelines.

The system also reduces communication load by allowing the server to send compact, structured display information instead of large map images or full video streams. The terminal reconstructs map views and augmented reality overlays locally using the structured data. This division of labor results in improved bandwidth efficiency and better utilization of processing capabilities of both the server and the terminal. The system further improves computation efficiency because route calculations and site prioritizations are performed on the server where more resources are available, while the terminal focuses on rendering, sensor integration, and user interaction.

In another embodiment, the server uses a machine learning model other than a generative text model to compute the risk index. For example, the server may use a neural network that takes as input features such as recent maximum seismic intensity, cumulative damage indicators, lifeline outage durations, road closure density, user age category, household size, and special support flags. The server trains the network on historical disaster outcome data using supervised learning and a loss function measuring the error between predicted risk levels and observed outcomes.

The server periodically retrains the model as new data becomes available, thereby improving prediction accuracy over time. The use of learned feature weights allows the server to capture complex interactions between environmental and user-specific factors that would be difficult to model manually, leading to more precise and timely risk assessments.

In a further embodiment, the terminal executes an augmented reality framework to align route information with real-space images. The terminal obtains camera pose information by combining inertial measurement data with visual feature tracking. The terminal uses this pose information to project the route geometry into screen coordinates. Because the server provides the route in a structured format tied to geographic coordinates, the terminal can perform this projection efficiently and update it as the user moves. This integration of server-side route generation and terminal-side sensor fusion enhances the accuracy and stability of augmented reality overlays, improving the user's ability to follow evacuation routes in complex environments.

In yet another embodiment, the server varies the structure and content of prompt sentences to achieve different operational goals. For instance, the server may generate prompt sentences focused on optimization of routing strategies, wording of notifications for elderly users, or prioritization of relief distribution sites. Example prompt sentences include:
“Please explain a method to calculate the optimal evacuation route based on a user's GPS location and to display this route visually using augmented reality technology on a smartphone, while minimizing processing load on the device.”
“Please describe in detail a method to monitor the status of lifeline supplies such as electricity and water in real time during a disaster, and to propose alternative means when supply is interrupted, in a way that can be implemented as server-side algorithms.”

By using such technical prompt sentences, the server can obtain design suggestions or parameter choices from the generative AI model and present them to system administrators for review. The server stores these suggestions and may incorporate them into updated rule sets or configuration files, further improving the technical performance of the system.

Through these embodiments, the server and the terminal implement a concrete, device-oriented disaster support system that goes beyond a mere abstract idea of information processing. The system tightly couples structured data storage, algorithmic risk computation, controlled generative AI usage, and device-level control of positioning, imaging, and display functions. As a result, the system achieves technical effects such as improved risk assessment accuracy, reduced response latency, improved data management, reduced communication overhead, and enhanced reliability and safety of generated guidance. These effects are causally linked to the specific data structures, processing algorithms, model architectures, and verification mechanisms described above, and would not be achieved by a mere manual process or a generic automation of human tasks.

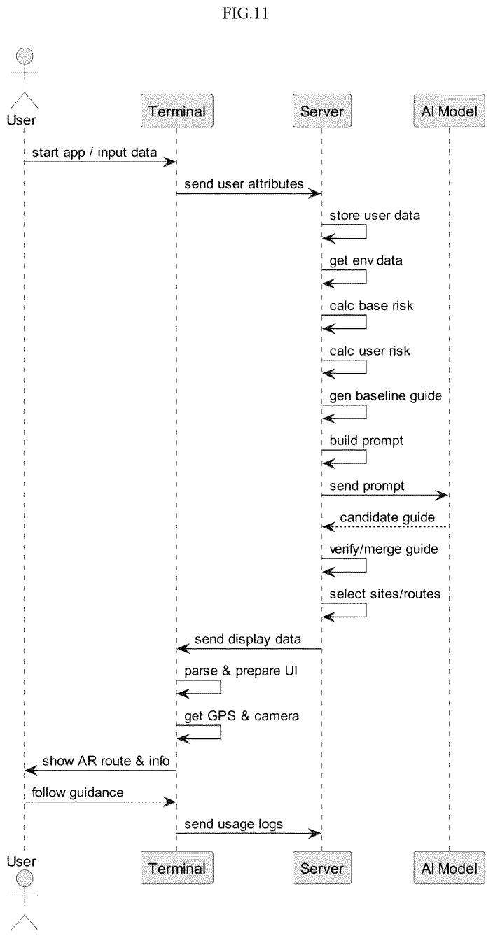

The following describes the processing flow using FIG. 11.

### Step 1:

The user operates the terminal to start a disaster support application and input user attribute information.

The terminal displays input fields for location reference information (such as postal code or address), age, household composition, and special support needs.

Input: Touch and/or voice input from the user.

Processing: The terminal converts the user's entries into structured electronic data, validates format and required fields, and encodes categorical items as internal codes.

Output: A structured user attribute record held in the terminal's memory, ready to be transmitted to the server.

### Step 2:

The terminal transmits the user attribute record to the server over a network.

The terminal establishes a secure connection, for example using HTTPS, serializes the user attribute record into a message body, and sends it to a designated server endpoint.

Input: The validated user attribute record generated in Step 1.

Processing: The terminal encapsulates the record into a network request, attaches authentication or session information if needed, and performs encryption at the transport layer.

Output: An encrypted network request containing the user attribute record, delivered to the server.

### Step 3:

The server receives and stores the user attribute information.

The server accepts the incoming network request, decrypts the transport layer, parses the message body, and maps the fields to internal database columns.

Input: The user attribute record transmitted by the terminal in Step 2.

Processing: The server validates the data against a schema, assigns or updates a user identifier, and inserts or updates a corresponding row in a user attribute table. The server may normalize strings into code values (for example, mapping age to an age range bucket).

Output: A persistent user attribute entry stored in the server's database with a unique identifier that links to location reference information.

### Step 4:

The server acquires environmental information from external information providing apparatuses using the location reference information.

The server composes one or more requests specifying geographic regions associated with the stored user location, sends these requests through a network interface, and receives structured environmental data.

Input: Location reference information and stored time-series environmental records (if any).

Processing: The server queries external services for recent seismic intensity, damage reports, lifeline status, road closures, and communication quality, parses returned messages, converts units or formats as needed, timestamps each record, and merges them into its time-series tables.

Output: Updated environmental information entries stored in a time-series database, associated with geographic regions relevant to the user.

### Step 5:

The server calculates a regional base risk value from the environmental information.

The server fetches recent environmental records for each relevant region and applies mathematical operations to derive a base level of disaster risk independent of user-specific attributes.

Input: Time-series environmental data for a region, such as seismic intensities, damage indicators, lifeline outage durations, and event frequencies.

Processing: The server computes aggregation statistics (e.g., maximum, average, weighted sums), applies a weighted moving average or a similar time-decay function to emphasize recent events, and normalizes the result to a standard scale.

Output: A regional base risk value for each region, stored as a numeric field in a regional risk table.

### Step 6:

The server adjusts the regional base risk value to compute a user-specific risk index.

The server loads the user attribute information and combines it with the regional base risk value using predetermined rules or a trained model.

Input: The regional base risk value from Step 5 and the user attribute entry from Step 3.

Processing: The server multiplies or adds correction factors based on age, household composition, and special support needs, and optionally applies a machine-learned model that maps these features to an adjusted risk level. This may involve computing a feature vector and applying stored model parameters to produce a scalar index.

Output: A user-specific risk index representing an individualized assessment of disaster risk, stored in a user risk table.

### Step 7:

The server generates a baseline set of action guidelines using deterministic rules.

The server reads the user-specific risk index and user attributes and evaluates rule conditions to select appropriate guideline templates.

Input: The user-specific risk index from Step 6 and the user attribute entry from Step 3.

Processing: The server executes rule evaluations (for example, “if risk index>threshold and user has mobility impairment then select early evacuation template”), fills template variables with current environmental details (such as latest seismic intensity and known shelter availability), and composes baseline instructions in text form.

Output: Baseline action guideline text that conforms to pre-defined system rules, stored as a preliminary guideline record.

### Step 8:

The server constructs a context-dependent prompt sentence for a generative AI model.

The server converts machine-readable context, including user attributes, environmental information, and the current risk index, into a human-readable description suitable as input to the model.

Input: The user attribute entry, the current environmental information for the user's region, and the user-specific risk index.

Processing: The server formats a text string that states the user's characteristics, current hazard level, and requested type of output (for example, step-by-step instructions or algorithmic improvements), and appends explicit constraints about safety, clarity, and target audience.

Output: A prompt sentence that encapsulates the current context and desired output behavior for the generative AI model.

### Step 9:

The server sends the prompt sentence to the generative AI model and obtains a candidate of the action guideline information.

The server forwards the constructed prompt sentence to a generative AI model interface, receives the response, and converts it into an internal representation.

Input: The context-dependent prompt sentence from Step 8.

Processing: The server transmits the prompt as text to the model, waits for the generated output stream, concatenates tokens or text segments, and removes formatting artifacts not suitable for further processing.

Output: A candidate guideline text or technical proposal generated by the generative AI model, represented as electronic text data.

### Step 10:

The server verifies the candidate guideline text using safety and reliability rules.

The server applies machine-readable constraints to identify unsafe or inconsistent statements and modify or delete them.

Input: The candidate guideline text from Step 9, safety rules, reliability rules, and current environmental information.

Processing: The server scans the candidate text using pattern matching and logical checks, compares instructions with a rule set that encodes official protocols and physical constraints, cross-checks factual claims against its environmental database, and flags or edits any segment that conflicts with the rules.

Output: A verified candidate guideline text that complies with safety and reliability rules, or a modified version of the candidate with unsafe content removed.

### Step 11:

The server merges the baseline guidelines with the verified candidate guidelines to form final action guideline information.

The server combines the deterministically generated instructions with the enhanced content produced by the generative AI model.

Input: The baseline guideline text from Step 7 and the verified candidate guideline text from Step 10.

Processing: The server selects standard critical instructions from the baseline set, attaches additional explanation, examples, or alternative measures from the verified candidate text, and orders the combined items according to predefined priorities, such as presenting life-critical steps first.

Output: Final action guideline information ready for distribution to the terminal, stored as part of a display information record.

### Step 12:

The server determines relevant relief distribution sites for the user.

The server loads site records and computes distances and priorities for each site based on the current position and user attributes.

Input: The user's current location reference or coordinates, the user attribute entry, and stored relief distribution site information.

Processing: The server calculates geographic distances using coordinate operations, estimates travel time using average speed assumptions or known route lengths, evaluates assumed congestion using time-of-day and historical usage data, and ranks sites according to a scoring function that considers distance, travel time, congestion, and suitability for special needs.

Output: A prioritized list of relief distribution sites with associated distances, estimated travel times, and attributes.

### Step 13:

The server determines relevant communication service providing sites for the user.

The server accesses communication infrastructure data and evaluates which locations offer relatively stable service.

Input: The user's current coordinates, communication base equipment position information, and communication quality information.

Processing: The server identifies coverage areas by comparing the user's location with base equipment positions and quality metrics, calculates distances and estimated travel times to candidate spots, and applies a ranking based on signal quality and proximity.

Output: A list of recommended communication service providing sites, each with coordinates, quality indicators, and access paths.

### Step 14:

The server generates display information for map and augmented reality rendering.

The server packages the final action guidelines, site lists, and route-related data into a structured format for the terminal.

Input: The final action guideline information from Step 11, the prioritized relief site list from Step 12, and the communication site list from Step 13.

Processing: The server represents site positions as geographic coordinates, encodes suggested routes as polylines or segment sequences, embeds priority levels and labels, and links each element to corresponding textual instructions for user interface display.

Output: Display information including guideline text, map elements, and augmented reality overlay descriptors, ready for transmission to the terminal.

### Step 15:

The terminal receives the display information and updates its user interface.

The terminal accepts the server's response, decodes the structured data, and stores it for immediate use.

Input: The display information transmitted from the server in Step 14.

Processing: The terminal parses map elements, converts geographic coordinates into the local map coordinate system, associates guideline text with interactive UI components, and prepares AR overlay instructions for later rendering.

Output: Internal data structures on the terminal representing evacuation routes, site markers, and associated guideline segments.

### Step 16:

The terminal acquires the current position and real-space image and renders the evacuation route in augmented reality.

The terminal activates its positioning and imaging functions to track the user and overlay guidance on the camera view.

Input: The route geometry and AR overlay descriptors from Step 15, and real-time sensor readings from the positioning function and imaging function.

Processing: The terminal computes a camera pose relative to the world coordinate system, projects route and site markers into the camera frame, draws arrows and markers on the live image, and updates the overlay as the user moves.

Output: A composite display on the terminal where real-space images are superimposed with evacuation route indications, relief site icons, and communication site icons.

### Step 17:

The user observes the rendered guidance on the terminal and follows recommended actions.

The user reads textual instructions, interprets AR overlays, and initiates evacuation or travel toward relief or communication sites.

Input: The visual and textual information rendered by the terminal in Step 16.

Processing: The user performs physical movements and actions based on the displayed guidance, such as turning off utilities, collecting emergency items, and moving along indicated paths.

Output: Real-world user behavior aligned with the computed risk index and action guidelines, enabling safer and more efficient disaster response.

### Step 18:

The terminal sends usage state information back to the server for continuous improvement.

The terminal records user interactions, such as which guidelines were opened, which routes were followed, and when notifications were acknowledged, and transmits this information to the server.

Input: Local logs of user actions and navigation states on the terminal.

Processing: The terminal aggregates events, anonymizes identifiers as needed, and sends the data to the server as structured usage state records.

Output: Usage state information stored on the server, enabling recalculation of risk indices, tuning of guidelines, and refinement of prompt sentences for future interactions.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional disaster information systems are typically designed as siloed applications that (i) retrieve static disaster information from external services, (ii) perform simple rule-based risk judgment, and (iii) present generic evacuation guidance to users. Such systems suffer from several technical limitations when deployed as large-scale, real-time, computer-implemented infrastructures in urban environments.

First, existing systems generally lack a unified data processing architecture that integrates heterogeneous sensing data, such as time-series signals from observation devices and image data from image acquisition devices, together with shelter information, traffic flow information, and urban infrastructure status. As a result, computation of evacuation routes frequently relies on outdated or coarse-grained inputs. This leads to suboptimal path computation, excessive recomputation, and inconsistent behavior across different processing modules, thereby degrading overall computational efficiency and reliability of the system.

Second, many systems do not perform fine-grained, spatially resolved risk estimation for multiple types of disasters. Hazard levels are often computed on a region-wide or administrative-unit basis using fixed thresholds, without calculating risk for each spatial unit and without dynamically updating risk according to real-time sensor data and feedback from users. This coarse approach impairs the ability of the computing system to allocate computational resources to high-risk areas, reduces the precision of route selection algorithms, and results in increased processing latency and unnecessary network traffic between servers and user terminals.

Third, conventional systems are typically not configured to jointly consider user attribute information, such as age, household composition, and special needs, when computing and updating evacuation routes. User interfaces on terminals merely display a single, generic route, and the server does not systematically incorporate user-specific constraints, such as mobility limitations, movement speed, or staircase avoidance, into the route evaluation logic. This lack of personalization not only reduces the practical usability of the guidance but also wastes available computing capacity by performing uniform processing for heterogeneous users.

Fourth, urban infrastructure control, such as signal control and operation control of transportation systems, is often decoupled from the disaster information computation pipeline. Infrastructure commands are manually designed or triggered through separate control systems, which are not tightly integrated with the hazard evaluation and route computation logic. This decoupling increases the complexity of system integration, introduces latency and inconsistency between computed routes and actual infrastructure states, and prevents the computing system from performing coordinated optimization of both information guidance and physical control.

Fifth, the use of generative AI models in this technical field has been limited to ad hoc or manual interactions. Existing systems do not include a processor-controlled mechanism to dynamically generate prompt sentences based on structured abstracted data representing disaster types, affected areas, shelter capacities, traffic congestion, and infrastructure control status.

Accordingly, generative AI models are not systematically integrated into the computational workflow for generating operator-oriented operation plans and general user-oriented guidance. The absence of structured prompt generation, logging, and analysis leads to non-repeatable behavior, difficulty in auditing system decisions, and an inability to iteratively improve both the underlying algorithms and the human-machine interaction.

In summary, there is a need for a computer-implemented system that (i) integrates heterogeneous disaster-related data sources into a unified processing pipeline, (ii) calculates multi-hazard risk on a per-spatial-unit basis, (iii) computes and dynamically updates personalized optimal evacuation routes, (iv) tightly couples evacuation computation with urban infrastructure control, and (v) systematically employs a generative AI model through dynamically generated prompt sentences and logged operation histories, thereby improving the technical performance, scalability, and adaptability of disaster response computing systems.

The specific processing by the specific processing unit 290 of the data processing device 12 in Application Example 1 is realized by the following means.

The present invention provides a server comprising a processor configured to acquire user attribute information, acquire regional disaster information and urban infrastructure information, integrate and preprocess time-series data and image data obtained from observation devices and image acquisition devices, calculate, for each spatial unit, a degree of risk associated with a plurality of types of disasters, evaluate evacuation routes on the basis of shelter information and traffic flow information, calculate an optimal evacuation route on the basis of a current position of a user and the user attribute information, deliver the evacuation route and behavioral guidance to a user terminal and control display of the evacuation route and the behavioral guidance on the user terminal, output, to an urban infrastructure control device, commands for signal control and operation control, dynamically generate a prompt sentence to be input to a generative information processing model by using abstracted data indicating a disaster type, an assumed affected area, a shelter accommodation status, a traffic congestion status, and an infrastructure control status, generate operator-oriented explanation information and general user-oriented guidance information on the basis of a response obtained from the generative information processing model, and record an operation history including the prompt sentence and the response with respect to the generative information processing model and analyze the operation history to improve processing for calculating the optimal evacuation route and processing for generating the prompt sentence. This enables a unified, computer-implemented disaster response platform that performs fine-grained multi-hazard risk computation, dynamically personalizes and updates evacuation routes, coordinates information guidance with urban infrastructure control in real time, and systematically leverages and refines interactions with a generative AI model, thereby improving processing efficiency, responsiveness, scalability, and reliability of the underlying computing architecture.

The term “user attribute information” refers to information representing characteristics of a user, including at least age information, household composition information, and information indicating whether the user requires special consideration, such as limited mobility, medical needs, or other constraints relevant to evacuation and disaster response.

The term “regional disaster information” refers to information indicating occurrence, intensity, type, or impact of a disaster within a specified geographic region, such as seismic intensity, flood level, fire occurrence, or other hazard-related metrics obtained from sensors, external information services, or administrative sources.

The term “urban infrastructure information” refers to information describing the operational state, configuration, or availability of physical infrastructure in an urban environment, including transportation networks, traffic signal states, public transportation schedules, road closures, and status of public facilities used during disasters.

The term “observation device” refers to a hardware device configured to measure physical phenomena and output time-series data, including but not limited to seismic sensors, water level sensors, temperature sensors, and other disaster-related measuring devices installed in an environment.

The term “image acquisition device” refers to a hardware device configured to capture still images or moving images, such as a camera or video recorder, deployed to monitor roads, public spaces, or facilities, and to provide image data for analysis in a disaster response system.

The term “time-series data” refers to numerical or symbolic data collected from a source at successive points in time, typically at uniform intervals, such as sequences of sensor readings representing changes in physical quantities over time.

The term “image data” refers to digital data representing a still image or a sequence of images, including, for example, pixel values, encoded video frames, or associated metadata used for visual analysis of scenes relevant to disaster conditions.

The term “integrate and preprocess” refers to operations by which the processor collects, normalizes, filters, aligns, and transforms heterogeneous data from multiple sources into a unified format suitable for subsequent analysis, including time alignment, noise reduction, outlier removal, feature extraction, and data aggregation.

The term “spatial unit” refers to a defined region of space used as a basic analysis unit in the system, such as a grid cell, polygon, or other subdivided geographic area, for which disaster-related risk and other metrics are calculated.

The term “degree of risk” refers to a quantitative or qualitative indicator representing a likelihood, severity, or expected impact of a specific type of disaster in a given spatial unit, computed on the basis of sensor data, historical data, and analytical models.

The term “plurality of types of disasters” refers to two or more different categories of hazardous events, such as earthquakes, floods, fires, storms, or other natural or man-made disasters considered in the computation of risk and evacuation strategies.

The term “shelter information” refers to information describing facilities designated as evacuation shelters, including location data, capacity data, current or estimated occupancy, accessibility conditions, and operational status during a disaster.

The term “traffic flow information” refers to information describing dynamic conditions of transportation routes, including vehicle density, average speed, congestion levels, road closures, and other factors influencing movement along roads or pathways.

The term “evacuation route” refers to a path or sequence of segments, defined over a transportation network or pedestrian network, from a current position of a user to a destination such as a shelter, computed by the processor in view of risk, traffic, and infrastructure conditions.

The term “optimal evacuation route” refers to an evacuation route selected by the processor from multiple candidate routes on the basis of a cost function that takes into account factors such as risk level, travel time, congestion, and user-specific constraints, so as to achieve a best or improved route according to predetermined criteria.

The term “current position of a user” refers to geographic coordinates or a location obtained for the user at a given time, for example through a positioning function of a user terminal or other localization mechanism.

The term “behavioral guidance” refers to information provided to a user indicating recommended actions to be taken in response to a disaster, including movement instructions, safety precautions, and timing or order of steps to be followed.

The term “user terminal” refers to a computing device operated by or accessible to a user, such as a mobile communication device, a portable computing device, or a fixed display device, configured to communicate with the server, receive information, and present guidance to the user.

The term “urban infrastructure control device” refers to a control system or apparatus that manages operational parameters of urban infrastructure components, such as traffic signal controllers, public transportation control systems, or display control systems, and that accepts commands from the server to modify infrastructure behavior.

The term “signal control” refers to control of signaling devices in infrastructure, including but not limited to traffic signals, by adjusting states, timings, or phases to influence movement of vehicles or pedestrians during an evacuation.

The term “operation control” refers to control of operational parameters of infrastructure systems, such as scheduling, routing, or availability of public transportation or other public services, in order to support disaster response and evacuation.

The term “generative information processing model” refers to a computational model, typically implemented as a machine learning model such as a generative language model, that produces output data such as natural-language text in response to input data, such as a prompt sentence, according to patterns learned from training data.

The term “prompt sentence” refers to a text string or structured input that describes a request, query, or context provided to a generative information processing model, and that guides the model to generate a corresponding response.

The term “dynamically generate a prompt sentence” refers to processing in which the processor constructs a prompt sentence at runtime based on current or recent system state, including disaster-related data, user-related data, or infrastructure-related data, rather than using only fixed, predefined text.

The term “abstracted data” refers to data that represent a summarized or generalized form of underlying detailed data, such as categorical indicators, aggregated metrics, or high-level descriptors of disaster type, affected area, shelter status, traffic congestion, and infrastructure control status.

The term “operator-oriented explanation information” refers to information generated for use by a system operator or administrator, including detailed technical explanations, analysis results, and operation plans, that support decision-making and control of the system.

The term “general user-oriented guidance information” refers to information generated for use by a non-expert user, including simplified explanations and concise instructions, expressed in plain language or other easy-to-understand form, for guiding behavior during a disaster.

The term “operation history” refers to recorded data representing sequences of operations performed by the system, including but not limited to prompt sentences sent to a generative information processing model, responses received from the model, and associated context such as timestamps, system states, and actions taken.

The term “analyze the operation history” refers to processing by which the processor inspects, aggregates, and evaluates the recorded operation history to identify patterns, errors, or performance characteristics, and to modify or tune algorithms or parameters for route calculation or prompt generation based on the identified information.

The term “evacuation policy” refers to a set of rules, preferences, or decision criteria used to plan, select, and adjust evacuation routes and guidance for a particular user or group of users, taking into account user-specific constraints and system-wide objectives.

The term “constraint conditions” refers to conditions or limitations that must be considered in computation of routes or guidance, such as available means of movement, expected movement speed, ability or inability to use stairs, and other physical or environmental restrictions.

The server, the terminal, and the user cooperate in various embodiments to implement the claimed invention. In the following description, the same reference to “the server,” “the terminal,” and “the user” is used to denote functional roles of computing equipment and human actors. The server may be realized by one or more physical computing machines, and the terminal may be realized by one or more user-side computing devices.

The server in one embodiment comprises a processor, a memory, a communication interface, and a non-transitory storage medium storing program instructions. The processor in one embodiment is a multi-core general-purpose processor, such as an x86 or ARM processor. The server in another embodiment further includes a graphics processing unit configured to accelerate matrix computation for neural networks. The memory stores intermediate data structures, such as time-series buffers and graph representations of road networks. The storage medium stores a relational database, a time-series database, a geospatial database, and trained model parameters of various machine learning models including a generative AI model.

The terminal in one embodiment is a portable communication device with a central processing unit, a display, a location acquisition unit, a communication interface, and a user input interface.

The terminal may be implemented as a handheld device running a mobile operating system. The terminal in another embodiment is a fixed display device such as a public information panel or digital signage device with a network interface and a rendering engine.

The user in one embodiment is a general citizen who receives evacuation guidance from the terminal. The user in another embodiment is an operator who monitors system status and supervises infrastructure control through a management terminal.

The server executes program instructions that implement data acquisition, data integration, multi-hazard risk calculation, route calculation, infrastructure control, prompt sentence generation, generative AI model interaction, and operation history analysis. The server, by executing these instructions, improves the operation of the underlying computing system by reducing redundant computations, decreasing network communication volume, and enabling more accurate and faster route computation compared to conventional rule-based systems.

The server, in an exemplary embodiment, uses general-purpose software components to implement the data storage layer. The server uses a relational database management system, such as a SQL-based database, to store user attribute information, shelter information, and operation logs. The server uses a time-series database, such as a key-value time-indexed store, to store sensor readings. The server uses a geospatial database, such as a database with spatial extension, to store road network graphs and spatial units with associated risk scores. These software components are executed under an operating system of the server.

The server uses data processing frameworks, such as a distributed batch and stream processing engine or a data analysis toolkit, to implement data aggregation, feature extraction, and normalization. The server uses a computer vision library to count vehicles and detect obstacles from images obtained from image acquisition devices. The server uses one or more deep learning frameworks to implement hazard prediction models and the generative AI model. These software stacks cooperate through defined APIs and data structures.

The server, in one embodiment, acquires user attribute information through communication with the terminal. The terminal presents an input screen that requests the user to input age information, household composition information, and information indicating special needs, such as use of a wheelchair or chronic illness. The terminal sends this information to the server through a secure communication protocol. The server stores the received user attribute information in a dedicated table that associates a user identifier with attributes such as age group, household size, and mobility classification.

The server acquires regional disaster information and urban infrastructure information from multiple external and internal sources. The server accesses observation devices through gateways that publish sensor readings. The observation devices output measurements at designated sampling intervals. The server maintains a subscription-based interface, such as a publish/subscribe mechanism, to continuously receive these measurements. The server timestamps each record and stores it in the time-series database along with a sensor identifier and spatial coordinates.

The server acquires urban infrastructure information by querying infrastructure control systems or by receiving periodic status reports. Such information includes current traffic signal phase states, planned public transportation timetables, real-time deviations in public transportation operations, and status of shelter facilities including open/closed status and current or estimated occupancy. The server stores such infrastructure information in structured tables, with indexes on location and time to support efficient queries.

The server integrates and preprocesses time-series data and image data obtained from observation devices and image acquisition devices. The server uses a data integration module that reads, for each processing interval, sensor readings from the time-series database, image frames from a storage or live stream, and infrastructure status from the relational database. The server aligns the data in time by mapping each reading to a discrete time window of predetermined length. The server handles missing values by interpolation or by marking them as missing where interpolation is not appropriate.

The server performs preprocessing operations to remove noise and outliers. The server, for example, applies a low-pass filter to seismic measurements to eliminate high-frequency noise.

The server calculates derived features such as peak ground acceleration, water level trend over recent time intervals, and rate of temperature increase. The server uses statistical methods such as z-score or robust statistics to remove outlier readings that deviate beyond a defined threshold.

The server applies image processing to frames captured by image acquisition devices, such as converting color spaces, performing background subtraction, and executing object detection models to detect vehicles and pedestrians.

The server uses graph-based data structures to represent a road network. The server stores, as entries in the geospatial database, nodes corresponding to intersections and segments corresponding to roads connecting nodes. Each segment has attributes such as length, maximum allowed speed, type (pedestrian, vehicular), and hazard modifiers. The server dynamically updates attributes, such as congestion level and passability, based on traffic flow information obtained from image analysis and external traffic services.

The server calculates a degree of risk associated with a plurality of types of disasters for each spatial unit. In one embodiment, the server defines spatial units as grid cells of a fixed dimension overlaid on the urban area. The server associates each sensor with one or more grid cells and aggregates sensor-derived features per grid cell. The server uses hazard-specific models to compute predicted risk values.

For seismic risk, the server uses a neural network that receives features such as peak ground acceleration, duration of shaking, and soil type characteristics of each grid cell. The neural network in one embodiment is a feed-forward neural network with multiple hidden layers. The network uses rectified linear unit activation functions and is trained using supervised learning on historical earthquake records paired with observed damage data. The server calculates, for each grid cell, an output value representing probability of building collapse or severe damage.

For flood risk, the server uses a model that combines current and past water level measurements with digital elevation data of the area. The server may use a convolutional neural network on a raster representation of elevation and water level, or a recurrent neural network on time-series of water levels. The network outputs an expected inundation depth or probability of flooding for each grid cell.

For fire risk, the server uses features such as localized high temperature increase, detection of smoke or flame patterns in image data, and recent history of seismic shaking. The server uses a classifier model that outputs a probability of fire presence or an intensity level for each spatial unit.

The server aggregates the outputs of these hazard-specific models into a multi-dimensional risk vector for each spatial unit. The server then calculates a composite risk level by applying a weighting function that can be configured according to disaster priorities. The server stores these risk levels in the geospatial database along with timestamps.

The server evaluates evacuation routes on the basis of shelter information and traffic flow information. The server maintains, for each shelter, attributes including capacity, current or estimated occupancy, accessibility, and limitations on entry. The server updates these attributes by receiving check-in reports from field operators or by estimating occupancy using historical patterns and route usage. The server calculates, for each shelter, a remaining capacity metric. The server computes, for each road segment, a cost value that reflects both travel effort and hazard. The server calculates this cost as a function of base travel time, congestion factor, and hazard factor derived from nearby grid cell risk values. The server, for example, increases the segment cost when the segment passes through a high-risk grid cell or when traffic congestion exceeds a threshold. The server stores the cost as an attribute on each segment in the road network graph.

The server calculates an optimal evacuation route for each user by performing a path search on the road network graph. The server uses an algorithm such as Dijkstra's algorithm or A* search.

The server sets the search cost of each segment to the calculated segment cost. The server sets a destination node corresponding to a shelter that satisfies constraints, such as remaining capacity and accessibility for the user's mobility profile. The server selects the path with minimum accumulated cost and records the sequence of nodes and segments as the optimal route.

The server delivers the evacuation route and behavioral guidance to the terminal. The server generates route information in a structured format that includes coordinates of waypoints, textual instructions for each turn or major decision point, and associated hazard annotations. The server also generates behavioral guidance messages that describe recommended actions in natural language. The server sends this information to the terminal over a network circuit using a request-response protocol.

The terminal displays the received route and guidance. The terminal uses a map rendering library to draw the route over a map background. The terminal overlays symbols representing hazards and shelters. The terminal displays textual instructions and may additionally output audio instructions. The terminal updates the display when receiving new route data from the server, for example when the server recalculates the route due to changing conditions.

The server outputs commands for signal control and operation control to an urban infrastructure control device to coordinate physical infrastructure with computed routes. The server selects traffic signals located along major evacuation routes and changes their timing programs or phase arrangements. The server, for example, extends the green phase in the direction of evacuation and shortens conflicting phases. The server sends such control commands using a communication protocol supported by the infrastructure control device.

The server also changes operation control parameters for public transportation systems. The server modifies schedules, routes, or stop usage to support evacuation flows. The server transmits commands to transportation control servers, which then adjust train or bus operations. These infrastructure control actions provide a direct technical effect in the physical world by altering traffic flows and transit availability in coordination with the computed evacuation routes.

The server dynamically generates a prompt sentence to be input to a generative AI model. The server first produces abstracted data that summarizes the current system state. Such abstracted data comprises symbolic descriptors of disaster type, affected area, shelter accommodation status, traffic congestion status, and infrastructure control status. The server maps this abstracted data to textual phrases using template functions and combines them into a coherent prompt sentence.

The server uses, in one example, a prompt sentence such as:
“Based on real-time data from city-wide seismometers, water level gauges, temperature sensors, and traffic cameras, explain a method to predict the impact area of a large disaster and provide optimal evacuation routes to citizens, considering road congestion and shelter capacity.”

The server uses, in another example, a prompt sentence such as:
“Please describe in detail how to control traffic infrastructure during a major flood, including how to prioritize evacuation routes, how to set traffic signals, and how to coordinate with public transportation services.”

The server uses, in another example, a prompt sentence such as:
“In the case where seismometers detect a large seismic event, water level gauges show rapidly rising levels in an eastern district, and traffic cameras indicate heavy congestion on a main highway, propose a detailed evacuation and traffic control strategy for the next three hours, including signal control, shelter allocation, and public transport rerouting.”

The server sends the generated prompt sentence to the generative AI model. The generative AI model in one embodiment is implemented as a large-scale neural network-based language model trained on a large corpus of text data. The neural network uses an architecture such as a transformer with multiple layers of self-attention and feed-forward sublayers. The generative AI model is deployed on a computing environment accessible to the server through a network interface.

The server controls parameters of the generative AI model, such as temperature and maximum output length, by including them in the model invocation. The server receives, from the generative AI model, a response text that corresponds to the prompt sentence. The server parses the response and extracts relevant portions to be used as operator-oriented explanation information or general user-oriented guidance information.

The server uses the generative AI model not as a black box but in conjunction with structured prompt generation and logging to improve the technical performance of the system. The server records, in an operation history, each prompt sentence and associated response, along with contextual metadata such as system state and actions taken following the response. The server later analyzes this operation history to identify which prompts and responses lead to successful operational outcomes, such as accurate hazard descriptions or effective route adjustments.

The server modifies prompt generation rules, weighting factors in risk calculations, and route cost functions based on analysis of the operation history. For example, when the server detects that certain prompts produce overly long or ambiguous responses, the server adjusts template construction to specify word limits or to request bullet-point outputs. This feedback loop allows the server to refine the interaction with the generative AI model in a systematic way, which reduces processing time for operator interpretation and improves consistency of system behavior. The server uses trained machine learning models not merely to replicate human judgment but to implement computational structures and algorithms that are not feasible using simple rule-based logic. The hazard models, for instance, learn non-linear relationships between sensor features and damage outcomes, enabling more accurate prediction in real-time. The server's route calculation module uses multi-objective cost functions and dynamic graph updates that allow for efficient re-computation when partial network changes occur, thereby reducing computation time relative to recomputing paths from scratch.

The server improves processing efficiency by caching intermediate results such as per-segment hazard modifiers and by incrementally updating only affected portions of the road network when risk values change. The server reduces network communication load by sending to the terminal only delta updates of routes when small changes occur, rather than transmitting full route data each time. The server further reduces computation overhead at the terminal by delegating heavy computations to the server while using lightweight rendering and UI logic on the terminal.

The terminal interacts with the server according to defined message formats. The terminal periodically sends the current position of the user to the server and requests updated route and guidance information. The terminal also provides an interface for the user to send feedback, such as reports of blocked roads or local hazards. The terminal attaches location and optional image data to such reports and transmits them to the server.

The server receives these user feedback reports and stores them in the relational database as part of the operation history. The server can apply image analysis to attached images to confirm reported obstacles. The server may then adjust road segment passability flags, trigger route recomputation, and modify prompts for the generative AI model to include references to newly observed obstacles. This integration of user observations, model-based analysis, and generative guidance creates a closed-loop system that improves accuracy and responsiveness.

The user interacts with the system mainly through the terminal. The user enters personal information when asked by the terminal. The user observes and follows evacuation routes displayed on the terminal. The user may report conditions to the server via the terminal. In another role as operator, the user uses a management interface on a terminal to view risk maps, review generative AI model responses, approve or reject proposed actions, and adjust configuration parameters.

The server, by integrating observation devices, urban infrastructure control devices, complex data processing pipelines, and generative AI models through prompt sentences and structured logging, achieves technical effects beyond simple automation of human judgment. The server reduces route computation time by optimizing graph operations and by using precomputed risk maps at the spatial unit level. The server improves prediction accuracy by using multi-layer neural networks trained with appropriate loss functions and optimized using gradient-based methods. The server reduces communication bandwidth by transmitting compressed or incremental updates and by using locally cached map data at terminals.

The server ensures that the use of the generative AI model does not introduce uncontrolled behavior by constraining prompts to structured, abstracted representations of system state and by discriminating between operator-oriented and general user-oriented outputs. This technical organization of generative processing allows the computing architecture to be predictable, auditable, and tunable.

The above description illustrates exemplary embodiments and variations. The server, the terminal, and the user may be configured in multiple alternative ways without departing from the scope of the claims. The server may be distributed across multiple physical machines. The terminal may be implemented as different types of computing devices. The hazard models may be implemented using different network architectures, such as convolutional networks, recurrent networks, or attention-based models. The generative AI model may be provided as an external service or implemented locally on the server. The fundamental technical features, including multi-hazard risk calculation per spatial unit, personalized route computation, integrated urban infrastructure control, structured prompt sentence generation and interaction with a generative AI model, and operation history logging and analysis, remain consistent across embodiments.

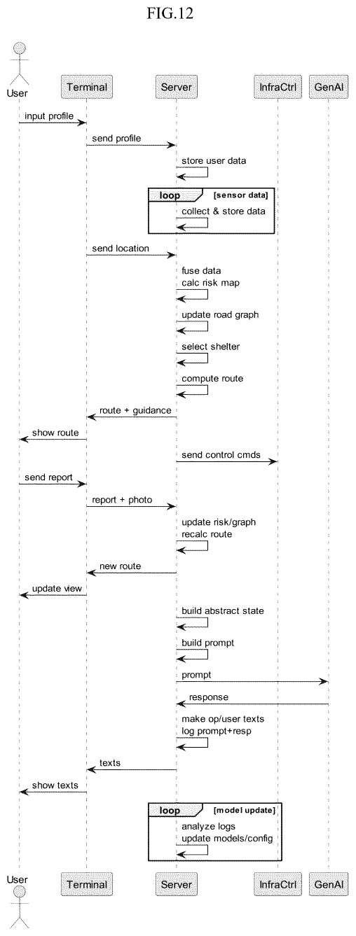

The following describes the processing flow using FIG. 12.

### Step 1:

The server acquires raw environmental and infrastructure data.

The server receives, as input, time-series sensor readings from observation devices, image streams from image acquisition devices, regional disaster information from external information services, and infrastructure status from infrastructure control systems. The server parses incoming packets, verifies checksums and timestamps, and discards corrupted or out-of-order data. The server converts protocol-specific payloads into internal records, each record including a sensor identifier, a measurement value, a timestamp, and a geographic coordinate. The server writes time-series data into a time-series database and stores infrastructure status and metadata in a relational database. The output of this step is a set of normalized raw data records persisted in storage, ready for integration and preprocessing.

### Step 2:

The server integrates and preprocesses heterogeneous data.

The server reads, as input, raw time-series records, image frames, and infrastructure status records stored in the databases during Step 1. The server aligns records by mapping timestamps to discrete time windows and by associating each record with a spatial unit identifier. The server applies filters to remove noise and outliers, for example by computing statistical metrics and discarding values outside a threshold range. The server calculates derived features, such as peak values, moving averages, and trends, for each sensor type within each spatial unit. The server processes image frames using computer vision algorithms to detect objects and estimate traffic density, producing numerical features such as vehicle count and occupancy ratio. The output of this step is a set of feature vectors per spatial unit and per time window, stored in an intermediate feature table.

### Step 3:

The server computes multi-hazard risk values per spatial unit.

The server takes, as input, the feature vectors generated in Step 2 and configuration data describing model parameters and hazard categories. The server loads trained neural network models for seismic, flood, and fire risk estimation, and passes the relevant feature components into each model. The server performs matrix multiplications and non-linear activations according to the network architecture to compute, for each spatial unit, hazard-specific output values such as probability of collapse, expected inundation depth, or probability of fire occurrence. The server then combines these hazard-specific outputs using a weighting function that reflects system configuration or operator preferences, thereby computing a composite risk score for each spatial unit. The output of this step is a multi-dimensional risk vector and a composite risk score stored for each spatial unit in a geospatial database.

### Step 4:

The server updates the road network graph with dynamic costs.

The server receives, as input, the composite risk scores per spatial unit from Step 3, static road network data, and traffic flow features obtained in Step 2. The server maps each road segment to one or more spatial units and calculates a hazard modifier for the segment by aggregating the risk scores of those spatial units. The server calculates a congestion factor for each segment using traffic features such as current speed and vehicle count. The server computes a dynamic cost value for each segment as a function of base travel time, hazard modifier, and congestion factor. The server writes the dynamic cost values back into the graph representation of the road network stored in the geospatial database or in memory. The output of this step is an updated road network graph in which each segment includes a current cost value used for route computation.

### Step 5:

The server acquires and stores user attribute information.

The terminal presents, as input, forms that allow the user to enter age, household composition, and special needs information. The terminal sends the entered data to the server using a secure communication protocol. The server receives the user attribute information, validates formats and value ranges, and assigns or confirms a user identifier. The server maps raw entries to standardized categories, such as age groups and mobility levels, and stores them in a user attribute table. The server may compute additional derived attributes, such as a maximum recommended walking distance or a set of forbidden infrastructure types (for example, stairs) based on the input. The output of this step is a persistent record for each user that associates the user identifier with attribute and constraint data used in later steps.

### Step 6:

The terminal acquires and transmits the current user position.

The terminal obtains, as input, positioning signals from a location acquisition unit, such as GPS or assisted location services. The terminal processes the raw positioning data to determine latitude, longitude, and an estimated accuracy value. The terminal packages this location information together with a user identifier and a timestamp and sends it to the server via a network. The server receives the position data, projects the coordinates onto the road network, and identifies the nearest node or segment in the graph. The output of this step is an association between each user and a current starting node in the road network graph stored on the server.

### Step 7:

The server selects candidate shelters and evaluates evacuation feasibility.

The server reads, as input, shelter information from a shelter database, including capacity, current occupancy, and accessibility properties, and reads user attribute information from Step 5. The server filters shelters to exclude those that are closed, full, or incompatible with the user's mobility constraints. The server computes, for each remaining shelter, a feasibility score that may depend on remaining capacity, distance, and hazard level around the shelter. The server orders shelters by this feasibility score and selects one or more candidate destinations for route calculation. The output of this step is a list of candidate shelters and associated feasibility metrics for each user.

### Step 8:

The server calculates an optimal evacuation route for each user.

The server takes, as input, the updated road network graph with dynamic segment costs from Step 4, the starting node determined in Step 6, and the candidate shelters selected in Step 7. The server runs a path-finding algorithm over the graph, using the segment cost as the weight for each edge. The server computes, for each candidate shelter, a path cost and selects the path with the lowest total cost value, subject to any additional constraints encoded by user attributes, such as maximum walking distance or avoidance of steep segments. The server collects the sequence of nodes and segments for the chosen path and converts it into a route description that includes geometry and high-level directions. The output of this step is an optimal evacuation route object associated with each user.

### Step 9:

The server generates machine-readable and human-readable route representations.

The server receives, as input, the optimal route object from Step 8, including node lists and segment attributes. The server converts the route into a polyline by transforming graph coordinates into geographic coordinates and interpolating intermediate points where appropriate.

The server generates turn-by-turn instructions by analyzing changes in direction and intersection types along the route. The server attaches hazard annotations, such as warning labels for segments near high-risk spatial units. The server formats a machine-readable representation, such as a JSON structure, and a human-readable representation, such as text instructions in natural language. The output of this step is a pair of representations for each route, ready for transmission to terminals and for storage in logs.

### Step 10:

The terminal receives route data and renders guidance to the user.

The terminal obtains, as input, the machine-readable route representation and the human-readable instructions from the server. The terminal parses the route data to extract polyline coordinates, instruction text, and hazard annotations. The terminal uses a map rendering component to display the route over a base map and highlights segments according to hazard level. The terminal displays step-by-step instructions and updates them as the user moves along the route, using fresh location information obtained from the location acquisition unit. The terminal optionally plays audio instructions using a text-to-speech engine. The output of this step is a dynamic graphical and textual presentation of the evacuation route on the terminal for the user.

### Step 11:

The server issues infrastructure control commands based on computed routes.

The server reads, as input, the set of optimal routes computed in Step 8 for multiple users and the positions of traffic signals and public transportation assets from infrastructure data. The server identifies intersections and segments that are part of a high density of routes and classifies them as evacuation corridors. The server determines control actions, such as extending green phases in the evacuation direction or prioritizing certain public transportation lines. The server creates control messages that encode new signal timing parameters or route changes for transit vehicles and sends these messages to the urban infrastructure control device using a supported protocol.

The output of this step is a sequence of infrastructure control commands that align physical traffic flows with the computed evacuation strategy.

### Step 12:

The user provides feedback and condition reports through the terminal.

The terminal presents, as input options, user interface elements for reporting road blockages, structural damage, or other hazards. The user selects a report category, optionally captures an image, and submits the report. The terminal attaches the user's current location and a timestamp to the report and sends it to the server. The server receives the feedback, stores it in a report table, and may trigger automated analysis such as image-based obstacle detection or cross-checking against existing hazard data. When the server confirms new obstacles or hazards, the server updates road segment passability or risk values and may initiate new route computations. The output of this step is enriched situational data that can adjust risk assessment and route planning.

### Step 13:

The server constructs an abstracted state description for generative processing.

The server gathers, as input, the current multi-hazard risk map from Step 3, the status of shelters from Step 7, the traffic and infrastructure status from Step 4 and Step 11, and recent user reports from Step 12. The server summarizes these detailed data into abstracted data elements, such as disaster type labels, identifiers of most affected districts, numerical indicators of shelter occupancy levels, categories of traffic congestion, and flags describing current infrastructure control actions. The server composes these abstracted elements into a structured internal representation, for example a set of key-value pairs indicating high-level system state. The output of this step is an abstracted state description suited for prompt sentence generation.

### Step 14:

The server generates a prompt sentence for the generative AI model.

The server takes, as input, the abstracted state description produced in Step 13 and one or more prompt templates corresponding to explanation requests, operation plan requests, or plain-language guidance requests. The server selects an appropriate template according to context, such as whether an operator is requesting assistance or whether citizen-facing guidance must be updated. The server fills variable slots in the template with textual phrases corresponding to elements of the abstracted state description. For example, the server may generate a prompt sentence such as:
“Based on current readings from seismic sensors, water level sensors, temperature sensors, and traffic cameras in the central and eastern districts, summarize the predicted impact area of the ongoing disaster and propose optimal evacuation strategies considering shelter capacity and road congestion.”

The server outputs the final prompt sentence as a plain text string ready to be sent to the generative AI model.

### Step 15:

The server invokes the generative AI model and processes its response.

The server supplies, as input, the prompt sentence from Step 14 and model configuration parameters, such as temperature and maximum token count, to the generative AI model via an API call. The generative AI model executes its internal neural network computation to produce a text response. The server receives the response as a string, segments it into structural parts if needed, and classifies sentences into operator-oriented information (for example, detailed operational steps) and general user-oriented information (for example, simplified guidance). The server may post-process the response by enforcing length constraints or by inserting standardized disclaimers. The output of this step is a set of candidate explanation texts and guidance texts derived from the generative AI model output.

### Step 16:

The server logs prompt-response pairs and updates system behavior.

The server records, as input, the prompt sentence from Step 14, the generative AI model response from Step 15, and contextual metadata such as timestamp, current risk levels, and subsequent actions taken by operators or the system. The server writes this information into an operation history table. Periodically, the server reads the stored logs and applies analysis procedures, such as clustering similar prompts, measuring time to operator approval, or correlating response types with operational outcomes. Based on this analysis, the server adjusts prompt templates, modifies weighting functions in risk aggregation, or updates parameters in route cost functions to improve decision quality and computational efficiency. The output of this step is updated configuration data that influence future risk calculations, route computations, and prompt generation.

### Step 17:

The terminal presents generative-model-based information to the appropriate user.

The terminal receives, as input, operator-oriented explanation information or general user-oriented guidance information generated in Step 15 and optionally refined by an operator. For an operator, the terminal displays structured plans, action lists, and commentary that help the operator understand the rationale behind infrastructure control and evacuation strategies. For a general user, the terminal shows simplified, clear instructions derived from the same underlying state but reformulated by the generative AI model. The terminal updates its user interface to distinguish between system-generated guidance and static information. The output of this step is a context-appropriate, generative-model-assisted presentation of information that supports human decision-making and action.

### Step 18:

The server updates and maintains learned models and configuration in light of system performance.

The server collects, as input, logs of prediction accuracy, route usage statistics, user response times, and prompt-response interaction performance from previous steps. The server uses these logs to retrain hazard prediction models on newly acquired labeled data, for example by using historical disaster events and confirmed outcomes to adjust neural network weights. The server executes training tasks that compute loss values, backpropagate errors, and update parameters using optimization algorithms such as stochastic gradient descent or its variants. The server also revises prompt templates and abstracted data mappings based on empirical effectiveness in producing actionable responses from the generative AI model. The output of this step is a set of updated model parameters and configuration rules that incrementally improve the system's accuracy, speed, and robustness over time.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional disaster information systems primarily rely on static or semi-static regional hazard indicators such as seismic intensity, building damage reports, and road closure information. These systems typically map such indicators to pre-authored, rule-based messages and route suggestions. As a result, the systems present essentially the same content to all users in the same area, regardless of users' emotional states, interaction behavior, or cognitive load.

When a disaster occurs, many users experience strong anxiety or panic, and cannot understand or act upon dense, text-heavy instructions or complex map displays. In such cases, even technically accurate guidance may be practically unusable, leading to delayed evacuation, misinterpretation of instructions, and failure to reach safe locations or essential resources.

Existing systems also suffer from architectural limitations. First, the systems do not integrate multimodal sensor data—such as voice, facial images, and interaction logs-into a unified emotional-state-aware control flow. The lack of an emotion recognition pipeline means that the user interface and content complexity cannot be adaptively tuned to the user's real-time mental state. Second, although generative AI models are capable of producing flexible natural language guidance, there is no systematic mechanism in the conventional systems for constructing and controlling prompt sentences on the basis of combined hazard evaluation, user attributes, and emotional state. As a consequence, naive use of generative AI may produce instructions that are too long, too complex, or unsafe, and cannot be properly constrained by the system. Third, existing route guidance modules do not dynamically switch between augmented reality display and multi-route map display according to the user's cognitive capacity and risk level; instead, they generally output a fixed style of map-based path, which is difficult to follow in panic conditions.

Furthermore, traditional system architectures do not use feedback from user behavior logs and emotional state transitions to iteratively improve their own message templates, user interface flows, and prompt-generation policies. Once deployed, such systems remain largely static, and do not exploit generative AI as a tool for system-level design optimization. This results in a technical deficiency: the human-computer interaction loop remains brittle under stress, and the disaster support platform cannot self-adapt its guidance strategies and display logic over time. Accordingly, there is a need for a computer-implemented disaster information system that (i) fuses regional hazard information, user attributes, and multimodal emotion recognition into a unified risk evaluation pipeline, (ii) programmatically constructs and constrains prompt sentences for a generative AI model based on that pipeline, (iii) dynamically adjusts the amount and format of information presented, including switching between augmented reality and multi-route map views, and (iv) uses generative AI outputs not only for user-facing guidance but also for continuous improvement of internal templates and interaction flows. From a computer-technology perspective, such a system should define processor-level workflows and data structures that improve the robustness, adaptability, and usability of disaster guidance under severe cognitive and environmental constraints.

The specific processing by the specific processing unit 290 of the data processing device 12 in Example 2 is realized by the following means.

The present invention provides a server comprising a processor and a memory storing instructions that, when executed by the processor, cause the processor to receive user attribute information and location information via a user information input unit; acquire and store disaster-related regional information corresponding to the location information from an external information providing apparatus via a regional information acquisition unit; extract features from at least one of voice information, image information, and operation history information of a user and estimate an emotional state of the user by applying a machine learning model to the features via an emotion recognition unit; calculate a degree of risk to the user as a numerical value or a class on the basis of the disaster-related regional information, the user attribute information, and the emotional state and determine an information presentation mode on the basis of the degree of risk via a risk evaluation unit; construct a prompt sentence to be input to a generative AI model on the basis of situation information including the degree of risk, the information presentation mode, the user attribute information, and the disaster-related regional information, input the prompt sentence to the generative AI model, and acquire, from the generative AI model, at least one of an action guideline and guidance information relating to a user interface via a generative AI utilization unit; control, on the basis of the acquired action guideline, the determined information presentation mode, and the estimated emotional state, at least one of an amount of information and a display format including a number of display characters, a display layout, and presence or absence of audio output, and present the action guideline via an action guideline provision unit; select an evacuation destination candidate on the basis of a current position of the user, the disaster-related regional information, and a result of the risk evaluation unit, calculate an evacuation route on the basis of road network information and hazardous location information, and present the evacuation route by at least one of a map display and an augmented reality display in accordance with the emotional state of the user and the information presentation mode via an evacuation route presentation unit; acquire position information and distribution content information relating to a supply point, select at least one supply point on the basis of the current position of the user and the result of the risk evaluation unit, and present a position and distribution content of the at least one supply point via a supply point guidance unit; acquire position information and communication quality information relating to a communication-possible point, select at least one communication-possible point on the basis of the current position of the user and the result of the risk evaluation unit, and present a position of the at least one communication-possible point via a communication point guidance unit; and analyze user behavior history information and transition information of the emotional state, generate a prompt sentence including summary information based on the user behavior history information and the transition information of the emotional state, input the prompt sentence to the generative AI model, acquire proposal information from the generative AI model, and update at least one of a template of the action guideline and a user interface flow on the basis of the proposal information via a performance improvement unit. This enables a technical improvement of the disaster information system architecture, in which the processor dynamically orchestrates multimodal emotion recognition, risk evaluation, prompt-controlled generative AI interaction, and adaptive presentation logic so as to generate constrained, context-appropriate guidance and route visualizations that remain usable under high cognitive load and to iteratively refine its own guidance and interface behavior based on logged user interaction and emotional responses.

The term “user attribute information” refers to information indicating characteristics of a user, including at least one of age, family structure, presence or absence of persons requiring special care, health condition, and other individual needs that are used for risk evaluation and guidance personalization.

The term “location information” refers to information indicating a geographic position associated with a user, including at least one of a postal code, an address, and coordinate data such as latitude and longitude, which is used to determine a target region for disaster-related information and route calculations.

The term “user information input unit” refers to a functional unit realized by hardware and software that receives user attribute information and location information through an input interface, such as a touch screen, keyboard, or communication interface, and supplies the received information to other processing units.

The term “disaster-related regional information” refers to information relating to a geographic region that is relevant to a disaster event, including at least one of seismic intensity, occurrence time, epicenter, building damage status, fire occurrence, road closure status, shelter availability, supply point status, and communication infrastructure status.

The term “external information providing apparatus” refers to an information processing apparatus or service outside the system that provides disaster-related regional information, including at least one of disaster information services, meteorological information services, road information services, and communication infrastructure information services.

The term “regional information acquisition unit” refers to a functional unit that accesses an external information providing apparatus on the basis of location information, acquires disaster-related regional information corresponding to the location information, and stores the acquired information in a memory.

The term “voice information” refers to audio data representing sounds produced by a user, including at least one of speech, breathing, and utterances, which is captured as a digital audio signal and used as input to emotion recognition processing.

The term “image information” refers to image or video frame data obtained from an imaging apparatus, including at least one of images of a user's face, body, and surrounding environment, represented as pixel values or derived features, and used as input to emotion recognition processing.

The term “operation history information” refers to time-series data indicating user interactions with a user interface, including at least one of touch positions, tap counts, tap intervals, swipe operations, input errors, and screen transition history.

The term “machine learning model” refers to an information processing model having internal parameters learned from training data, which derives output values from input data, and includes at least one of neural networks, decision trees, and support vector machines.

The term “emotional state” refers to information indicating a psychological condition of a user, represented as a category such as calm, mild anxiety, strong anxiety, panic, confusion, or fear, or as a numerical score corresponding to such categories.

The term “emotion recognition unit” refers to a functional unit that extracts features from at least one of voice information, image information, and operation history information and estimates an emotional state of a user by applying a machine learning model to the extracted features.

The term “degree of risk” refers to an index indicating a level of physical or psychological danger to a user in a disaster situation, computed on the basis of at least disaster-related regional information, user attribute information, and the emotional state, and represented as a numerical score or a discrete class.

The term “information presentation mode” refers to a classification of a style of presenting information to a user, including at least one of a minimal information mode, a standard mode, and a detailed mode, which defines an amount of information, complexity of content, and type of display format to be used.

The term “risk evaluation unit” refers to a functional unit that receives disaster-related regional information, user attribute information, and an estimated emotional state as inputs, calculates a degree of risk to the user, and determines an information presentation mode on the basis of the degree of risk.

The term “prompt sentence” refers to text data containing at least one of instruction phrases, condition descriptions, and constraint descriptions, which is input to a generative AI model to cause the generative AI model to generate desired output content in accordance with a given situation.

The term “generative AI model” refers to a trained information processing model that generates new text or other content on the basis of input text or structured situation information, and includes at least a large language model or other generative model capable of producing natural language output.

The term “generative AI utilization unit” refers to a functional unit that constructs a prompt sentence on the basis of situation information including at least a degree of risk, an information presentation mode, user attribute information, and disaster-related regional information, inputs the prompt sentence to a generative AI model, and acquires at least one of an action guideline and guidance information relating to a user interface from the generative AI model.

The term “action guideline” refers to natural language guidance information indicating concrete actions that a user should take in a disaster situation, including at least one of whether to evacuate, when to evacuate, which route to take, how to secure lifelines, and how to access communication means.

The term “action guideline provision unit” refers to a functional unit that, on the basis of an action guideline acquired from a generative AI model, an information presentation mode, and an emotional state, controls at least one of an amount of information and a display format and presents the action guideline to a user.

The term “display format” refers to a configuration of how information is presented on a display device, including at least one of a number of display characters, a size of characters, a layout, colors, arrangement of UI elements, and presence or absence of audio output.

The term “current position of the user” refers to geographic location information of a terminal associated with a user at a given time, including at least latitude and longitude data obtained from a positioning subsystem.

The term “evacuation destination candidate” refers to information indicating a possible target location to which a user can evacuate, including at least a shelter, a safe open space, or another designated safe area, which is evaluated and selected on the basis of risk and distance.

The term “road network information” refers to data representing a structure of transportation paths, including at least roads, intersections, pathways, and their connectivity, which is used to compute routes between a current position and a destination.

The term “hazardous location information” refers to information indicating locations associated with increased danger, including at least road closures, structurally unsafe areas, flooded areas, or other dangerous segments, which is used to modify route calculations.

The term “evacuation route” refers to route information indicating a path from a current position of a user to an evacuation destination candidate along a road network, determined in consideration of hazardous location information and safety constraints.

The term “evacuation route presentation unit” refers to a functional unit that selects an evacuation destination candidate, calculates an evacuation route on the basis of road network information and hazardous location information, and presents the evacuation route to a user by at least one of a map display and an augmented reality display in accordance with an emotional state and an information presentation mode.

The term “map display” refers to a display mode in which geographic information is presented as a two-dimensional map image, and in which an evacuation route or points of interest are drawn as graphical elements on the map.

The term “augmented reality display” refers to a display mode in which computer-generated graphical elements, including at least arrows or route lines, are superimposed on real-world images acquired from an imaging apparatus, to visually indicate directions or paths in the real environment.

The term “supply point” refers to a facility or location at which at least one of drinking water, food, or daily necessities is provided to disaster-affected persons.

The term “distribution content information” refers to information indicating types and quantities of supplies provided at a supply point, including at least categories of items and availability intervals.

The term “supply point guidance unit” refers to a functional unit that acquires position information and distribution content information relating to supply points, selects at least one supply point on the basis of a current position of a user and a result of risk evaluation, and presents a position and distribution content of the at least one supply point.

The term “communication-possible point” refers to a location at which a communication state is relatively stable after a disaster and at which at least one of voice communication and data communication is possible.

The term “communication quality information” refers to information indicating a quality of communication at a location, including at least one of signal strength, available bandwidth, latency, and connection stability.

The term “communication point guidance unit” refers to a functional unit that acquires position information and communication quality information relating to communication-possible points, selects at least one communication-possible point on the basis of a current position of a user and a result of risk evaluation, and presents a position of the at least one communication-possible point.

The term “user behavior history information” refers to recorded data indicating past interactions and movements of a user with respect to a system, including at least one of responses to guidance, time taken to start evacuation, route-following behavior, and user interface operation sequences.

The term “transition information of the emotional state” refers to information indicating changes in a user's emotional state over time, including at least a sequence of emotional state labels and associated timestamps.

The term “performance improvement unit” refers to a functional unit that analyzes user behavior history information and transition information of the emotional state, generates a prompt sentence including summary information based on the analyzed information, inputs the prompt sentence to a generative AI model, acquires proposal information from the generative AI model, and updates at least one of a template of an action guideline and a user interface flow on the basis of the proposal information.

The term “template of the action guideline” refers to a structured pattern for generating action guideline text, including predefined sections, placeholders, and style rules, which are filled or adjusted based on situational variables and outputs of a generative AI model.

The term “user interface flow” refers to a sequence and structure of user interface screens, interactions, and transitions that define how a user navigates through functions of a system during operation, including at least initial prompts, confirmation dialogs, and step-by-step guidance screens.

In the following embodiments, server, terminal, and user cooperate to implement the claimed system. Each sentence uses “Server”, “Terminal”, or “User” as the subject, and the description focuses on concrete computer-technical structures, data flows, and algorithms.

### 1. System Architecture (Hardware and Software)

Server operates on a general-purpose computing device including at least one central processing unit, a volatile memory, a non-volatile storage device, and a network interface. Server executes an operating system such as a generic server operating system and runs middleware including a web application framework, a database management system, and a machine learning framework. Server, in one embodiment, uses a web application framework such as a generic web framework (for example, a framework of the type of Spring Boot or Django), a relational database management system of a standard type (for example, a database of the type of PostgreSQL or MySQL), and a machine learning framework of a deep-learning type (for example, a framework of the type of TensorFlow or PyTorch). Server also uses an HTTP client library to call external disaster information services and a generative AI model service via network.

Terminal operates on a mobile information processing device such as a smartphone or a tablet. Terminal executes a mobile operating system such as a generic mobile OS and runs a native or cross-platform application implementing the client-side functions. Terminal includes at least a display, a touch input surface, a microphone, a camera, a positioning subsystem (for example, a GNSS receiver), motion sensors (accelerometer and gyroscope), and a wireless communication module (for example, cellular and wireless LAN). Terminal executes UI code using a mobile UI framework (for example, a framework of the type of Android Jetpack Compose, Android View system, SwiftUI, or a comparable toolkit) and uses platform APIs for audio capture, camera control, and location retrieval.

User operates the terminal and provides user attribute information and location information, receives action guidelines, and follows route presentations in the physical environment.

### 2. Data Structures and Storage

Server stores user attribute information and location information in a user table of the relational database. Server, in one embodiment, defines columns such as user_id (primary key), age, family_structure_code, special_needs_flags, home_postal_code, home_address_code, and registration_timestamp. Server uses normalized codes (for example, enumeration values) for family structure and special needs to reduce storage size and to speed up risk evaluation queries. Server stores disaster-related regional information in a region_info table keyed by a region identifier such as a postal code or municipality code. Server stores, for each region, fields such as latest_seismic_intensity, last_earthquake_timestamp, building_damage_level, fire_incident_flag, road_closure_ratio, shelter_availability_index, communication_infrastructure_status, and derived risk parameters (for example, historical_damage_score).

Server stores emotional state records in an emotion_info table containing columns such as user_id, emotion_label, emotion_score, estimation_timestamp, and estimation_source (terminal, server, or fused). Server stores user behavior history information and transition information of the emotional state in dedicated log tables, with schema designed to support aggregation by batch jobs.

Terminal stores locally a user identifier and latest emotional state in a key-value storage area provided by the mobile operating system and maintains in-memory buffers for raw audio samples, video frames, and UI operation events, which are periodically reduced into feature vectors.

### 3. Emotion Recognition (Features, Models, and Training)

Terminal performs concrete signal processing and feature extraction rather than relying on abstract “emotion detection”. Terminal uses an audio API to capture PCM samples at a fixed sampling rate (for example, 16 kHz) and divides the data into frames of, for example, 25 ms with 10 ms overlap. Terminal applies a window function (for example, Hamming window) and then applies a Fast Fourier Transform using a numerical library. Terminal converts the frequency spectrum into Mel-frequency bands and computes Mel-Frequency Cepstral Coefficients (MFCCs). Terminal may compute first and second derivatives (delta and delta-delta) to capture temporal dynamics.

Terminal uses an image processing library to perform face detection on each image frame captured from the camera. Terminal applies a cascade classifier or a small convolutional neural network to locate facial bounding boxes, crops the face region, rescales it to a standard resolution (for example, 64×64 pixels), normalizes pixel intensities (for example, mean subtraction and division by standard deviation), and optionally extracts facial landmarks (for example, eye positions, mouth corners, eyebrow positions).

Terminal aggregates UI operation history into numeric features. Terminal, for each time window, counts tap events, calculates tap interval statistics, counts erroneous inputs (for example, backspace operations, validation failures), and counts screen transitions. Terminal constructs a fixed-length feature vector for interaction behavior (for example, [tap_count, error_tap_ratio, transitions_per_minute, average_tap_interval]).

Terminal concatenates the audio feature vector, image feature vector, and UI interaction feature vector into a single multi-modal feature vector and normalizes the combined vector using statistics determined during training.

Terminal applies a neural network model for local emotion estimation. Terminal, in one embodiment, uses a small multilayer perceptron or a shallow convolutional network, converted into a mobile inference format (for example, a format of the type of TensorFlow Lite or Core ML), with an input dimension equal to the feature vector size, one or more hidden layers with nonlinear activation functions (for example, rectified linear units), and an output layer producing logits for emotion classes. Terminal uses a softmax function to convert logits into probabilities. Server trains this local model offline using supervised learning. Server collects labeled training data containing pairs of feature vectors and human-annotated emotion labels such as calm, mild anxiety, strong anxiety, and panic. Server defines a loss function such as categorical cross-entropy, uses an optimizer such as stochastic gradient descent or Adam, and updates network weights via backpropagation. Server optionally applies data augmentation (for example, adding noise to audio features, random cropping and flipping of face images) to increase robustness.

Server then deploys the trained model weights to terminal devices.

Server performs more complex emotion recognition when additional computation is available.

Server uses deeper architectures such as a convolutional neural network for faces and a recurrent network or transformer-based encoder for audio features. Server fuses modalities by concatenating high-level feature embeddings from each network and passes them through fully connected layers to obtain refined emotion probabilities. Server uses a fusion algorithm that combines terminal output and server output (for example, a weighted average with weights determined by model confidence) to derive a final emotion_label and emotion_score.

This configuration improves emotion recognition accuracy compared to rule-based heuristics, because the neural networks learn non-linear relations between multi-modal features and emotional categories, and the two-stage local/server model structure balances latency and accuracy.

### 4. Risk Evaluation Logic and Data Flow

Server evaluates the degree of risk using a structured computational pipeline rather than a generic “if-then” rule set. Server obtains, for a given user, the latest regional information vector R (for example, R=[seismic_intensity, building_damage_level, fire_incident_flag, road_closure_ratio, historical_damage_score]), the user attribute vector U (for example, U=[age, family_structure_code, special_needs_flags]), and the emotional state vector E (for example, one-hot or soft probabilities for each emotion class plus emotion_score).

Server, in one embodiment, computes a scalar risk_score using a linear or non-linear function. Server may implement risk_score=wR·R+wU·U+wE·E+b, where wR, wU, and WE are weight vectors and b is a bias term. Server determines these parameters by training a regression or classification model on historical disaster outcome data. Alternatively, server may use a small neural network taking R, U, and E as inputs to produce risk_score.

Server maps risk_score to discrete risk classes such as immediate evacuation, evacuation preparation, and situation confirmation by comparing risk_score with threshold values. Server also determines an information_presentation_mode by mapping risk_score and emotion_label to one of minimal_information, standard_information, and detailed_information.

Server thereby improves computational efficiency and consistency: risk evaluation becomes a deterministic, machine-executable function using numeric vectors and learned parameters, which reduces manual rule maintenance, reduces evaluation time (to constant or low-degree polynomial in feature dimension), and enables easy re-training when new data becomes available.

### 5. Prompt Sentence Construction for the Generative AI Model

Server constructs a prompt sentence based on internal data structures representing the current state. Server, for each user session, builds a situation object S containing fields such as age, family_structure, seismic_intensity, damage_description, emotion_label, and information_presentation_mode. Server applies a template carried in a text resource file:
“You are a disaster support assistant.

Create a short message in simple Japanese that explains only one action the following user should take right now.

### [User Information]

Age: {{age}}
Family: {{family_structure}}
Local seismic intensity: {{seismic_intensity}}
Damage in surroundings: {{damage_description}}
Emotional state: {{emotion_label_with_explanation}}

### [Requirements]

Use a calm and polite tone.
Do not use technical terms.
Describe only one action that should be done within the next 5 minutes.”

Server replaces placeholders such as {{age}} and {{seismic_intensity}} with actual values.

Server adjusts the requirements section according to risk and emotion. For example, server, when risk_score is high and emotion_label is panic, explicitly inserts constraints “only one action” and “no technical terms” into the prompt sentence. When risk_score is low and emotion_label is calm, server may insert:
“Include a brief explanation of why this action is recommended and provide two alternative options if appropriate.”

Server sends the constructed prompt sentence to a generative AI model service via an HTTP request. Server passes the prompt as plain text, not as JSON content, while the HTTP body may contain meta-data in JSON as required by the API protocol.

Server can also construct improvement prompts for internal performance optimization. For example, server generates:
“The following logs are behavior records of users of a disaster evacuation app.

For each case, analyze why the user may not have followed the instructions and propose how to change wording or step division.

### [Log Summary]

Case 1: user was in panic state. Instruction ‘Immediately head to the nearest shelter’ was shown, but the user did not operate the app for 5 minutes . . . . ”

Server uses this prompt sentence to instruct the generative AI model to output analysis and suggestions for revising templates and flows.

This explicit, parameterized prompt construction is a non-conventional computational procedure. Server uses structured numeric risk and emotion outputs to control the prompt grammar and constraints. This improves reliability and safety compared to ad hoc prompts, because different risk/emotion combinations map to specific, pre-defined constraint sets, reducing the chance of generating content that is too long, complex, or unsafe.

### 6. Generative AI Model Invocation and Validation

Server invokes a generative AI model service that provides a large language model with a transformer architecture. Server sends the prompt sentence, model identifier, and decoding parameters (for example, temperature, maximum tokens, and top-k or nucleus sampling parameters) via an HTTP API. Server receives a response containing one or more candidate texts. Server validates the generated text with explicit checks. Server applies a content filter that scans for prohibited tokens or patterns such as suggestions to use elevators during earthquakes. Server checks that the number of characters does not exceed a threshold determined by the selected information_presentation_mode. Server, optionally, uses an auxiliary classifier model trained to detect unsafe or confusing instructions and rejects or modifies outputs that fail this classifier.

Server, when a generated text violates a safety or length constraint, can either truncate the text according to sentence boundaries or regenerate by adding stricter constraints to the prompt sentence (for example, adding “limit to 50 characters and do not mention elevators”).

This combination of numeric model outputs (risk and emotion), structured prompt construction, and post-generation validation yields a reproducible, machine-controlled text generation process. The process reduces error rate and increases safety compared to manual or static message selection.

### 7. Adaptive Action Guideline Presentation

Terminal uses the action guideline text, the information_presentation_mode, and the emotional state to choose a concrete UI layout. Terminal implements layout templates for minimal, standard, and detailed modes.

Terminal, in minimal_information mode and for panic or strong anxiety states, uses a view hierarchy with one full-screen text element and one button. Terminal sets a large font size, high-contrast colors, and centers the main instruction. Terminal hides or defers supplementary explanations behind a secondary screen or collapsible region that is not initially visible. Terminal optionally initializes a text-to-speech engine provided by the OS and synthesizes speech for the main instruction, which helps visually impaired users or users not looking at the screen.

Terminal, in detailed_information mode for calm states, uses a multi-section layout where the main instruction appears at the top, and collapsible sections show reasons, step-by-step descriptions, and future outlook. Terminal accepts user taps on the section headers to expand or collapse content.

This adaptive UI is not a trivial automation of human tasks. Terminal dynamically changes low-level rendering parameters (font size, layout structure, presence or absence of certain controls) according to computed mode and emotion values. This improves interaction efficiency: a panic user sees only one large instruction and one button, which reduces time-to-understand and mis-tap errors, while a calm user can access more detailed information.

### 8. Evacuation Route Calculation and Augmented Reality Control

Server computes candidate evacuation destinations and passes them to terminal, but terminal performs route calculation and augmented reality overlay control. Terminal, given current GPS coordinates and a set of candidate shelter coordinates, uses a map SDK to obtain a road network graph. Terminal invokes a pathfinding algorithm such as Dijkstra or A* implemented within the SDK or locally. Terminal weights edges of the graph not only by distance but also by hazard level, as indicated by hazardous location information. Terminal, for example, adds a high penalty weight to segments that are flagged as closed or dangerous, thereby automatically avoiding those segments unless absolutely necessary.

Terminal, when the emotional state is panic and information_presentation_mode is minimal, chooses the single path with lowest combined cost and switches to an augmented reality display mode by initializing an AR framework. Terminal obtains camera frames, device pose (position and orientation) using sensor fusion of the accelerometer, gyroscope, and GPS, and renders arrows or lines that indicate the next segment. Terminal overlays those graphics on the camera feed with proper perspective transforms.

Terminal, by controlling camera feed, 3D projection, and overlay parameters in real time, materially changes how the display hardware outputs photons. This is a concrete machine control effect, not a mere abstract display of numbers. The path selection algorithm that considers emotional state and hazardous segments yields shorter decision times and avoids congested or blocked areas, reducing overall evacuation time.

Terminal, when the emotional state is calm and information_presentation_mode allows more complexity, shows multiple candidate paths on a 2D map, each drawn with different colors. Terminal annotates each path with labels indicating estimated travel time and the number of hazardous segments. User can tap one path to select it, and terminal updates the navigation guidance accordingly.

### 9. Supply Point and Communication Point Guidance

Server computes nearest supply points and communication-possible points using spatial queries on the region data. Server uses indexes such as R-tree or GiST index on latitude and longitude columns of the supply point table and communication_point table to speed up nearest-neighbor searches. This lowers response latency even when the database contains many candidate points. Terminal receives the top-ranked points and renders them on the map or as minimal icons and text, again adapting the layout by mode and emotion. Terminal, for panic users, displays only the closest supply point with a simple message such as “You can get water and food here.” Terminal, for calm users, displays a list including distribution content information and expected congestion level, computed by the server based on historical or real-time data.

This combination of indexing and adaptive rendering produces tangible technical effects: query time is reduced, bandwidth usage is limited to top results, and the rendered content is matched to user capability, improving overall system performance and reliability.

### 10. Performance Improvement Loop Using Generative AI

Server exploits generative AI not only for front-end guidance but also for system-level improvement. Server periodically runs batch processes that query behavior_log and emotion_info tables. Server aggregates data into case descriptions where users did not follow instructions or performed unexpected actions. Server, for each case, constructs a textual summary that includes user attributes, risk level, emotional state sequence, guidance shown, and observed behavior.

Server then builds a prompt sentence combining multiple case summaries and instructions such as:
“The following logs are behavior records of users of a disaster evacuation app.

For each case, analyze why the user may not have followed the instructions and propose how to change wording or step division.

### [Log Summary]

Case 1: user was in panic state. Instruction ‘Immediately head to the nearest shelter’ was shown, but the user did not operate the app for 5 minutes . . . . ”

Server submits this prompt to the generative AI model and receives analysis text. Server parses the suggestions to identify actionable changes such as “split instructions into shorter steps”, “add reassurance phrases”, or “show confirmation questions”. Server updates configuration files or template patterns stored in the database (for example, rewriting templates used for prompt sentences or on-screen messages) and may change UI flow definitions (for example, adding an intermediate “check surroundings” step).

This loop improves the underlying computer system architecture: the generative AI model helps optimize internal guidance logic and UI structure that control program execution, leading to lower error rates and more efficient processing. The system's behavior is updated based on quantitative behavior logs, enabling technical adaptation beyond simple business rules.

### 11. Technical Effects and Improvement of Computer Technology

Server and terminal jointly implement a multi-stage, multi-modal processing pipeline that is not a simple computerization of manual procedures. The pipeline introduces:
A multi-modal neural emotion recognition subsystem with explicit feature extraction and training using well-defined loss and optimization procedures.
A risk scoring unit that maps numeric vectors to risk scores using learned parameters, enabling rapid recalculation and easy re-training.
A prompt-construction engine that programmatically generates constraint-rich prompt sentences from internal state, enabling consistent control of a generative AI model.
An adaptive UI subsystem that reconfigures layout and modality (text vs AR, single vs multiple routes) according to computed risk and emotion, directly affecting hardware usage (display, audio, camera).
An improvement loop that uses generative AI to propose modifications to the system's own templates and interaction flow, enabling continuous improvement of guidance precision and user interaction quality.

These elements provide technical effects such as improved inference accuracy of emotional state, reduced latency of risk evaluation and route computation, reduced communication overhead by sending only minimal necessary data and results, and reduced user mis-operation and misunderstanding. The system thereby improves the functioning of the computer platform itself in the specific context of disaster support, rather than simply automating pre-existing human messaging procedures.

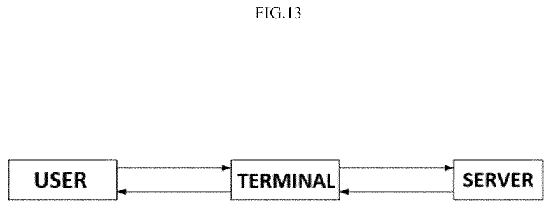

The following describes the processing flow using FIG. 13.

### Step 1:

User starts the disaster support application and inputs basic information.

User provides, as input, address-related location information (postal code, address) and user attribute information (age, family structure, special needs flags) by operating input fields on the terminal's touch screen.

Terminal receives tap and text input events from the mobile OS, converts them into internal string and numeric variables, and aggregates them into a structured “user registration object”. Terminal performs local validation (for example, regular expression checks on postal code, range checks on age). Terminal serializes the validated object into a JSON-like text structure. Terminal outputs the JSON-form “user registration data” and sends it to the server over an encrypted HTTPS connection.

### Step 2:

Server registers user information and stores it in the database.

Server receives, as input, the user registration data from the terminal via a web application framework. Server parses the JSON text into a user data structure and applies a validation library to check mandatory fields and format consistency. Server performs data processing by generating a unique user identifier and mapping textual fields (for example, family structure) into internal codes. Server writes the resulting record into a user table in the relational database. Server outputs a response object containing the user identifier and status information. Terminal receives the response, extracts the user identifier, and stores it in local persistent storage for later use.

### Step 3:

Server acquires and updates disaster-related regional information.

Server uses, as input, the stored location information (postal code or region code) for each user or for a target region. Server constructs HTTP requests to external disaster information services and sends queries via an HTTP client library. Server receives JSON responses containing seismic intensity, building damage, fire incidents, and road closure flags. Server parses these responses and converts textual or categorical fields into numeric codes and scores. Server stores the processed data into a region_info table keyed by region code and updates derived parameters such as historical_damage_score by aggregating past entries. Server outputs the updated regional information records as database state for later risk evaluation.

### Step 4:

Terminal collects audio, image, and operation history data for emotion recognition.

Terminal uses, as input, real-time sensor signals: PCM audio samples from the microphone, image frames from the camera, and UI operation events from the touch interface. Terminal buffers raw audio samples in a ring buffer, stores recent image frames in memory, and logs UI events with timestamps in a local log structure. Terminal outputs synchronized segments of raw audio, image frames, and operation logs for a predefined time window (for example, 30 seconds), which are used as input to feature extraction.

### Step 5:

Terminal generates multi-modal emotion feature vectors.

Terminal receives, as input, the raw audio segment, image frames, and operation logs for the current time window. Terminal uses a signal processing library to perform windowing and fast Fourier transforms on the audio and computes Mel-Frequency Cepstral Coefficients and their derivatives. Terminal uses an image processing library to detect the user's face, crops and normalizes the face region image, and converts it to a standardized feature array. Terminal analyzes the operation logs to compute numerical statistics such as tap count, error rate, and screen transition rate. Terminal concatenates these audio, visual, and interaction features into a fixed-length multi-modal feature vector. Terminal outputs this “emotion feature vector” as input to the local emotion estimation model.

### Step 6:

Terminal estimates the user's emotional state locally.

Terminal uses, as input, the emotion feature vector produced in Step 5. Terminal loads a pre-trained neural network model (for example, a small multilayer perceptron or shallow convolutional network) via a mobile inference runtime. Terminal performs a forward pass of the feature vector through the network, computing weighted sums and non-linear activations in each layer to obtain class logits. Terminal applies a softmax function to convert logits into probabilities for emotion classes such as calm, mild anxiety, strong anxiety, and panic. Terminal selects the class with the highest probability as the local emotion label and uses the highest probability as the emotion score. Terminal composes a local emotion state object containing user identifier, emotion label, emotion score, and timestamp. Terminal outputs this object and, when a threshold or label-change condition is met, sends it to the server as input for server-side refinement.

### Step 7:

Server refines the emotional state estimation and stores the result.

Server receives, as input, the local emotion state data from the terminal, and optionally associated feature summaries. Server loads high-capacity emotion recognition models implemented in a deep learning framework, such as a convolutional network for facial images and a recurrent or transformer-based model for audio features. Server performs a forward pass on the received features, computing new class probabilities. Server combines these probabilities with the local probabilities using a fusion rule (for example, weighted averaging based on model confidence) to generate a final probability distribution. Server selects the final emotion label and score from this distribution. Server writes a row into the emotion_info table recording user identifier, final emotion label, emotion score, and timestamp. Server outputs the final emotional state as stored database state for use in risk evaluation and presentation control.

### Step 8:

Server evaluates the degree of risk and determines an information presentation mode.

Server uses, as input, the final emotional state, the user attribute record, and the current regional information record for the user's location. Server constructs numeric vectors representing regional factors (for example, seismic intensity, building damage level, road closure ratio), user factors (for example, age code, special needs flags), and emotional factors (for example, one-hot emotion vector, emotion score). Server applies a risk evaluation function, which may be implemented as a weighted sum or a small neural network, to compute a scalar risk score. Server compares the risk score to pre-defined thresholds to classify the situation into risk classes such as immediate evacuation, evacuation preparation, and situation confirmation. Server then maps the combination of risk class and emotional state to an information presentation_mode (for example, minimal, standard, detailed). Server stores this risk evaluation result and presentation mode in a user_state table. Server outputs the risk class, risk score, and information_presentation_mode as inputs for prompt construction and guidance generation.

### Step 9:

Server constructs a prompt sentence for the generative AI model.

Server receives, as input, the risk evaluation result, emotional state, user attributes, and regional information. Server places these values into a prompt template that contains placeholders for user characteristics, hazard description, emotional state description, and requested style constraints. Server performs string substitution to replace placeholders with concrete values (for example, “Age: 80”, “Local seismic intensity: 7”, “Emotional state: panic”). Server further adjusts the constraint section based on the information presentation_mode and emotional state. For a high-risk, panic user, server constructs a prompt sentence such as:
“You are a disaster support assistant.

Create a short message in simple Japanese that explains only one action the following user should take right now.

### [User Information]

Age: 80
Family: lives alone
Local seismic intensity: 7
Damage in surroundings: partial building collapses and fires reported
Emotional state: panic (strong anxiety and confusion)

### [Requirements]

Use a calm and polite tone.
Do not use technical terms.
Describe only one action that should be done within the next 5 minutes.”

Server outputs this prompt sentence as text and sends it to the generative AI model service as input for guidance text generation.

### Step 10:

Server invokes the generative AI model and validates generated guidance.

Server uses, as input, the constructed prompt sentence from Step 9. Server submits the prompt to a generative AI model service via an API, specifying decoding parameters such as maximum length and sampling temperature. Server receives a generated response text from the service.

Server applies content-processing operations: scanning the text for prohibited phrases, checking that the length does not exceed a limit derived from the information presentation_mode, and optionally passing the text through an auxiliary classifier to detect unsafe suggestions. Server, if the text violates any constraint, modifies or regenerates it by adjusting the prompt or truncating the output at sentence boundaries. Server then finalizes an “action guideline text” that conforms to safety and length requirements. Server outputs this action guideline text, together with the risk class and information_presentation_mode, as input to the action guideline provision logic and as payload for transmission to the terminal.

### Step 11:

Server packages action guidelines and related metadata for transmission.

Server receives, as input, the finalized action guideline text from Step 10 and the risk evaluation result. Server splits the text into a primary instruction (for example, the first imperative sentence) and optional supplementary explanation sentences, by detecting sentence boundaries. Server constructs a guidance data structure containing fields such as main_instruction, supplementary_explanation, risk_class, information_presentation_mode, and optionally recommended destination identifiers. Server serializes this structure into a JSON-like format and sends it over HTTPS to the terminal. Server outputs this serialized “guidance packet” as the response to the terminal's request.

### Step 12:

Terminal displays the action guideline according to the mode and emotional state.

Terminal uses, as input, the guidance packet received from the server and the latest local emotional state. Terminal parses the packet to obtain main_instruction, supplementary_explanation, risk_class, and information_presentation_mode. Terminal selects an appropriate UI template: for example, if mode is minimal and emotion is panic, terminal chooses a full-screen, single-instruction layout, whereas if mode is detailed and emotion is calm, terminal chooses a multi-section layout. Terminal configures text size, color, and layout based on template parameters and renders the main_instruction prominently on the display. Terminal may hide supplementary_explanation behind a “More details” control if the mode is minimal. Terminal optionally uses a text-to-speech engine to synthesize audio output of the main_instruction.

Terminal outputs rendered UI content and audio output as the physical presentation to the user.

### Step 13:

Server selects evacuation destination candidates and guidance points.

Server receives, as input, the user's current geographic coordinates, which the terminal periodically sends, and the risk evaluation result. Server queries the region_info, shelter_info, supply point, and communication_point tables to retrieve candidate shelters, supply points, and communication-possible points within a search radius. Server uses spatial indexing and distance formulas to compute the distance from the user's position to each candidate and applies filters based on disaster-related regional information (for example, excluding shelters in heavily damaged areas). Server ranks candidates by a composite score combining distance, safety, and capacity. Server selects top-ranked shelters and points as evacuation destination candidates and resource locations. Server outputs a “route guidance input set” containing coordinates, point types, and recommendation scores, and transmits this set to the terminal as input for route computation and display.

### Step 14:

Terminal computes evacuation routes and presents them via map or augmented reality.

Terminal uses, as input, the route guidance input set from the server and its own latest position. Terminal constructs or retrieves a road network graph from a map library, where nodes represent intersections and edges represent road segments. Terminal assigns weights to edges based on distance and hazard indicators (for example, adding penalty weights for segments near hazardous locations). Terminal runs a pathfinding algorithm such as Dijkstra or A* to compute the least-cost path(s) from the current position to each candidate destination. Terminal decides how many routes to present based on the emotional state and information_presentation_mode: for a panic user, terminal selects only the best-scored route; for a calm user, terminal may select multiple routes. Terminal then either renders a 2D map display with polylines and labels (route time, hazard count) or switches to augmented reality mode, where it overlays direction arrows and route lines onto the live camera feed using the AR framework and device pose estimation. Terminal outputs dynamic navigation visuals on the display, updated as the user moves.

### Step 15:

Server analyzes behavior logs and improves templates using the generative AI model.

Server uses, as input, accumulated user behavior history information and emotional state transition logs stored over multiple sessions. Server runs batch processes to extract cases where users did not follow recommended actions or exhibited delays. Server summarizes each case into a textual description including context, guidance presented, and observed behavior. Server concatenates multiple case summaries into an analysis prompt sentence such as:
“The following logs are behavior records of users of a disaster evacuation app.

For each case, analyze why the user may not have followed the instructions and propose how to change wording or step division.

### [Log Summary]

Case 1: user was in panic state. Instruction ‘Immediately head to the nearest shelter’ was shown, but the user did not operate the app for 5 minutes . . . . ”

Server sends this prompt sentence to the generative AI model and receives explanatory and prescriptive text. Server parses this text to extract proposed changes (for example, suggestions for shorter steps or more reassuring wording). Server updates stored action guideline templates and UI flow definitions in configuration tables based on these proposals. Server outputs revised templates and flow configurations that will be used in subsequent executions of Steps 9-12, thereby closing a technical feedback loop that improves the system's guidance behavior over time.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional disaster information systems mainly focus on acquiring physical disaster data such as seismic intensity, flood levels, fire occurrences, and traffic disruptions, evaluating hazard levels based on those data, and presenting static or rule-based guidance messages and evacuation routes to users. In such systems, the computing logic typically maps sensor readings and regional risk levels directly to pre-defined text templates or fixed user interface patterns. As a result, the content, length, tone, and level of detail of the presented guidance are not dynamically adapted to the psychological state of each user or to the collective emotional condition of people in a specific area. This causes several technical problems in the functioning of the computer system.

First, when the system provides detailed and high-volume information to a user who is in a state of strong anxiety or panic, the user interface and message content become difficult to process cognitively, which leads to increased response time and lower comprehension. From a computer-technical viewpoint, the system's output generation pipeline cannot adapt its data selection, formatting, and interaction patterns to the user's current cognitive bandwidth, because the internal models do not take multimodal emotional features into account when generating guidance. The mismatch between system output complexity and user processing capability reduces the effectiveness of the human-computer interaction and results in inefficient utilization of communication bandwidth and screen space.

Second, existing systems do not integrate group-level emotional signals into the core risk evaluation and control logic. Even when multiple users' devices send rich interaction logs, conventional server-side processing pipelines treat such data only as individual contexts or ignore them altogether. The server does not compute group emotion indices per area and therefore cannot adjust global control actions (such as prioritizing which zones to serve, how to schedule server resources, or how to orchestrate infrastructure devices) based on the combined physical and psychological load of each spatial area. This leads to suboptimal allocation of computing resources and network resources: for example, the server may not prioritize message generation and delivery for areas where panic is rapidly spreading, and infrastructure control may not be synchronized with real-time crowd anxiety dynamics.

Third, although generative AI models can produce natural language guidance, conventional integrations use static or manually crafted prompts that do not encode fine-grained, real-time risk indicators and emotional states. The server typically passes a generic prompt to a generative model without conditioning on detailed sensor-derived risk indicators, user-level emotional estimations, and group emotion indices. Consequently, the generated text may be overly general, inappropriate in tone, or misaligned with the current cognitive state of the intended recipients. From a computer-technical perspective, this represents an underutilization of the generative model's conditioning interface and results in a non-adaptive text generation pipeline where the server cannot systematically regulate model behavior according to machine-evaluated risk and emotion signals.

Fourth, existing systems often treat information provision and infrastructure control as disjoint subsystems. The hazard evaluation module may produce risk scores for traffic signals or public transport controllers, but these scores are not tightly coupled with user- and group-level emotional estimations. As a consequence, the control commands to infrastructure devices are based solely on physical metrics such as congestion or hazard intensity, and do not leverage rich multimodal feedback from user devices. This separation prevents the server from implementing coordinated strategies where guidance messages and infrastructure control are jointly optimized based on both composite risk and crowd emotional state, thereby limiting the system's ability to prevent panic escalation and manage evacuation flows efficiently.

Therefore, there is a need for an improved computer-implemented disaster information system in which a processor: (i) collects multimodal user interaction features and estimates individual emotional states; (ii) computes group emotion indices per spatial area and combines them with physical disaster risk indicators to evaluate composite risk; (iii) uses the composite risk and emotional states to dynamically determine guidance policies; (iv) automatically generates structured, constraint-rich prompt sentences for a generative AI model in accordance with the guidance policies; and (v) coordinates guidance presentation and infrastructure control based on the outputs of the generative model and the composite risk evaluation. By restructuring the internal data processing pipeline and control logic in this way, the computer system can technically improve its adaptability, responsiveness, and resource allocation, and can generate and deliver guidance that is better aligned with the users' emotional and cognitive states in real time.

The specific processing by the specific processing unit 290 of the data processing device 12 in Application Example 2 is realized by the following means.

The present invention provides a server comprising a processor and a memory storing instructions which, when executed by the processor, cause the processor to acquire user attribute information, individual needs information, operation history information, voice feature information, facial expression feature information, location information, and motion state information from one or more information processing terminals, to acquire, based on geographical identification information, disaster-related information for plural spatial areas, to aggregate physical quantity data, image data, and video data obtained from a plurality of detection devices and image acquisition devices in association with time information and location information and to calculate statistical values for each spatial area, to calculate, based on the disaster-related information and the statistical values, a disaster risk indicator for each spatial area, to input the operation history information, the voice feature information, the facial expression feature information, the location information, and the motion state information into a machine learning model to estimate an emotional state of each user, to aggregate emotional states of a plurality of users belonging to a same spatial area based on the location information and to calculate a group emotion index for each spatial area, to evaluate a composite risk for each spatial area by combining the disaster risk indicator and the group emotion index, to determine, based on the emotional state of a target user and the composite risk of a spatial area to which the target user belongs, at least content, level of detail, expression format, and presentation medium of guidance information to be presented to the target user or a group, to generate, by template processing, a prompt sentence for a generative AI model, the prompt sentence including at least a role instruction to the generative AI model, an output format specification, a character count constraint, and a tone specification and reflecting the determined guidance information, the emotional state of the target user, and the disaster risk indicator and the group emotion index of the spatial area, to input the prompt sentence into the generative AI model and to obtain, as an output of the generative AI model, a natural language text as the guidance information, to transmit the natural language text together with associated route information to at least one of a portable information processing device and a public display device so that the guidance information is visually or audibly presented and an evacuation route is superimposed on a map display, and to control at least one traffic control device and at least one public transportation control device based on the composite risk and the group emotion index so as to adjust traffic flow and human flow along an evacuation route. This enables a computer system to dynamically adapt its internal data processing, natural language generation, user interface control, and infrastructure control according to real-time multimodal emotion estimations and composite disaster risk evaluations, thereby technically improving the efficiency, relevance, and stability of disaster-time guidance and control operations performed by the system.

The term “user information acquisition unit” refers to a functional unit implemented by a processor that acquires, from one or more information processing terminals, user-related data including user attribute information, individual needs information, operation history information, voice feature information, facial expression feature information, location information, and motion state information.

The term “region information acquisition unit” refers to a functional unit implemented by a processor that acquires disaster-related information for a target spatial area based on geographical identification information such as an address, a code, or coordinate data.

The term “observation information processing unit” refers to a functional unit implemented by a processor that aggregates physical quantity data, image data, and video data obtained from a plurality of detection devices and image acquisition devices, associates the data with time information and location information, and calculates statistical values for each spatial area.

The term “hazard evaluation unit” refers to a functional unit implemented by a processor that calculates, based on disaster-related information and statistical values derived from observation data, a disaster risk indicator for each spatial area indicating at least one of structural damage risk, flood risk, fire risk, or traffic disruption risk.

The term “disaster risk indicator” refers to a value or set of values computed for each spatial area that quantitatively or qualitatively represents a level of physical disaster risk, including at least one of structural damage risk, flood risk, fire risk, or traffic disruption risk, based on sensor data and historical disaster information.

The term “emotional state estimation unit” refers to a functional unit implemented by a processor that inputs operation history information, voice feature information, facial expression feature information, location information, and motion state information into a machine learning model and estimates an emotional state of a user as one of a plurality of predefined emotional categories or a corresponding score.

The term “group emotion index calculation unit” refers to a functional unit implemented by a processor that aggregates emotional states of a plurality of users belonging to a same spatial area based on location information and calculates at least one group emotion index, such as an average anxiety score or a proportion of users having a high-anxiety or panic tendency, for each spatial area.

The term “group emotion index” refers to a value or set of values representing an aggregated emotional condition of a plurality of users within a same spatial area, computed by combining individual emotional states, and including at least one metric such as an average emotional score, an anxiety level index, or a ratio of users in high-anxiety or panic categories.

The term “composite risk evaluation unit” refers to a functional unit implemented by a processor that evaluates, for each spatial area, a composite risk by combining a disaster risk indicator and a group emotion index, for example using a weighted formula or rule set, to represent an integrated assessment of physical and psychological risk.

The term “composite risk” refers to an evaluation value for each spatial area obtained by combining a physical disaster risk indicator and a group emotion index so as to represent a degree of overall risk that jointly reflects physical hazard level and crowd emotional state.

The term “guidance policy determination unit” refers to a functional unit implemented by a processor that determines, based on an emotional state of a target user and a composite risk of a spatial area to which the target user belongs, at least content, level of detail, expression format, and presentation medium of guidance information to be presented to the target user or to a group.

The term “guidance information” refers to information presented to a user or a group for supporting disaster-time behavior, including at least natural language text describing evacuation routes, destination shelters, safety procedures, priority actions, and warnings, and optionally including associated map displays, icons, or audio instructions.

The term “prompt sentence generation unit” refers to a functional unit implemented by a processor that generates, by template processing or dynamic text composition, a prompt sentence for a generative AI model, the prompt sentence reflecting at least a determined guidance policy, the emotional state of a user, and the disaster risk indicator and group emotion index of a spatial area.

The term “prompt sentence” refers to text input to a generative AI model that specifies at least a desired role of the model, an output format, one or more constraints such as length and tone, and conditions including disaster risk information and emotional state information, so as to condition the model to generate appropriate guidance information.

The term “generative AI model execution unit” refers to a functional unit implemented by a processor that provides a prompt sentence and configuration parameters to a generative AI model, obtains a generated natural language text from the model as an output, and supplies the generated text as guidance information to other units.

The term “generative AI model” refers to a machine learning model, typically realized by a neural network with a large number of parameters, that generates natural language text or other data in response to input text such as a prompt sentence, and that can be configured to follow specified roles, tones, and formatting constraints.

The term “guidance information provision unit” refers to a functional unit implemented by a processor that transmits guidance information including a natural language text, and optionally associated route or display information, to at least one portable information processing device or public display device so that the guidance information is visually or audibly presented.

The term “route display unit” refers to a functional unit implemented by a processor that presents an evacuation route by superimposing route information, such as coordinate sequences or path segments, on a map display in association with guidance information.

The term “resource distribution guidance unit” refers to a functional unit implemented by a processor that, based on aggregated spatial area information, presents positions of resource distribution points and information on provided resources, such as types of supplies and distribution times.

The term “communication site guidance unit” refers to a functional unit implemented by a processor that, based on communication condition information such as base station status or signal quality, presents position information of sites where communication is relatively stable or easy.

The term “infrastructure control unit” refers to a functional unit implemented by a processor that controls at least one traffic control device and at least one public transportation control device based on a composite risk and a group emotion index so as to adjust traffic flow and human flow along an evacuation route.

The term “traffic control device” refers to an electronic control apparatus that manages traffic signals or road guidance devices at intersections or road sections and is capable of changing signal cycles, signal phases, or display states in response to control commands.

The term “public transportation control device” refers to an electronic control apparatus or system that manages operation of public transportation, including at least trains or buses, by controlling schedules, routes, stopping patterns, headways, or additional services in response to control commands.

The term “information processing terminal” refers to a portable information processing apparatus, such as a mobile communication device or tablet, that includes at least a processor, a memory, a display, an input interface, a wireless communication interface, a location acquisition function, and one or more sensors, and that executes an application program for communicating with a server and presenting guidance information.

The term “spatial area” refers to a region obtained by dividing a geographic space into units, such as grid cells, administrative divisions, or predefined zones, and used as a unit for computing disaster risk indicators, group emotion indices, and composite risks.

The term “operation history information” refers to data representing user interactions with an information processing terminal, including at least touch events, button presses, text inputs, and their timestamps, positions, frequencies, or error occurrences.

The term “voice feature information” refers to data representing characteristics of a voice signal captured by a microphone, including at least energy, fundamental frequency, spectral distribution, speech rate, and silence ratio, obtained after signal processing without necessarily retaining original audio content.

The term “facial expression feature information” refers to data representing characteristics of a user's facial expression estimated from image data or video data, including at least numerical scores or probabilities corresponding to emotion-related categories such as joy, anxiety, anger, sadness, or neutrality.

The term “motion state information” refers to data representing a motion state of a user or an information processing terminal, including at least states such as stationary, walking, running, or in-vehicle, estimated based on location changes and sensor outputs.

The term “geographical identification information” refers to information used to identify a location or region, including at least a postal code, an address, geographic coordinates, or an area code.

The term “physical quantity data” refers to data output from sensors that measure physical phenomena relevant to disasters, including at least seismic acceleration, water level, temperature, smoke concentration, vehicle flow, or crowd density.

The term “image acquisition device” refers to a device equipped with an imaging sensor, such as a camera, capable of capturing image data or video data of an environment including roads, public spaces, or facilities for the purpose of monitoring disaster-related conditions.

The term “detection device” refers to a sensor apparatus configured to measure at least one physical quantity related to a disaster, including devices such as seismometers, water-level gauges, temperature sensors, smoke detectors, or traffic sensors.

The term “public display device” refers to a display apparatus installed in a public space and visible to a plurality of persons, including at least digital signage, information panels, and station or road-side displays that can present textual or graphical guidance information.

In one embodiment, a system for disaster-time guidance and infrastructure control includes at least one server, a plurality of terminals carried by users, a set of detection devices and image acquisition devices deployed in an urban space, a plurality of public display devices, and a plurality of infrastructure control devices such as traffic control devices and public transportation control devices.

### A. Hardware and Software Configuration

The server executes a general-purpose server operating system, for example a Linux-based operating system, on hardware including at least one central processing unit (CPU), a main memory, a non-volatile storage device such as a solid-state drive, a network interface, and optionally one or more graphics processing units (GPUs). The server executes application server software, for example a web application framework implemented in a general-purpose language, a relational database management system, a message broker software for stream processing, a machine learning framework such as a tensor computation library (e.g., PyTorch), and client software for accessing an external generative AI model via an application programming interface.

Each terminal is a portable information processing device such as a mobile communication device or a tablet. The terminal includes a processing unit, a memory, a touch-sensitive display, a camera, a microphone, a wireless communication interface supporting cellular and wireless local area network communication, a satellite positioning receiver, and motion sensors such as an accelerometer and a gyroscope. The terminal executes a mobile operating system, for example a smartphone operating system, and runs a native disaster-response application on top of the mobile operating system.

Each detection device is a sensor apparatus such as a seismic sensor, a water-level gauge, a temperature sensor, a smoke detector, or a traffic sensor. Each image acquisition device is a camera or similar imaging device installed at roads, stations, or public squares. Each public display device is a digital signage or information panel connected via a network to a display control server. Each infrastructure control device is a traffic signal controller or public transportation operation controller that provides an interface for external control commands.

### B. Functional Configuration of the Server

The server functions as a user information acquisition unit. The server receives, from each terminal, user-related data including user attribute information, individual needs information, operation history information, voice feature information, facial expression feature information, location information, and motion state information. The server stores these data in one or more tables in the relational database using structured records that associate a user identifier, a timestamp, and feature fields.

The server functions as a region information acquisition unit. The server obtains, based on geographical identification information such as address or coordinates, disaster-related information for target spatial areas from external information sources, for example public disaster information services, meteorological data services, and administrative data feeds accessed via standard web APIs.

The server functions as an observation information processing unit. The server receives, via a message broker or direct network interfaces, physical quantity data, image-derived features, and video-derived features from the detection devices and image acquisition devices. The server attaches time and location metadata to each record and aggregates the data per predefined spatial area, for example by dividing a geographic region into grid cells or administrative zones. The server then computes statistical values such as averages, maxima, minima, and temporal trends per spatial area and per sensor type.

The server functions as a hazard evaluation unit. The server calculates, for each spatial area, one or more disaster risk indicators based on the aggregated statistical values and historical disaster records. In one embodiment, the server uses a regression model or a gradient-boosted decision tree model implemented in the machine learning framework, which receives as input normalized sensor statistics and outputs a numeric score representing structural damage risk, flood risk, fire risk, or traffic disruption risk. The server stores these indicators as structured fields in a block-risk table.

The server functions as an emotional state estimation unit. The server receives from each terminal a feature vector composed of operation history features (such as tap frequency and swipe speed), voice features (such as energy, fundamental frequency, and speech rate), facial expression scores (such as probabilities of anxiety or neutral state), location coordinates, and motion state labels. The server normalizes each dimension of the feature vector using pre-stored mean and variance values, converts the vector into a tensor of a fixed length, and inputs the tensor into a multimodal neural network model implemented in the machine learning framework and executed on the GPU.

In one example, the neural network model is a multi-branch feedforward neural network. The server configures a first branch to process operation features, a second branch to process audio features, and a third branch to process facial expression scores. Each branch includes several fully connected layers with nonlinear activation functions such as rectified linear units. The outputs of the branches are concatenated and input into one or more shared fully connected layers, followed by a softmax output layer over emotional categories including at least normal, mild anxiety, strong anxiety, confusion, and panic tendency. The server uses a cross-entropy loss function during training and updates the model weights by stochastic gradient descent or an adaptive gradient method. The server may apply data augmentation strategies, for example synthetic noise on feature values or random scaling of timing parameters, to improve robustness. The server obtains from the neural network a probability distribution over emotional categories. The server determines an emotional state label by selecting the category with the highest probability or by applying a thresholding rule for certain categories. The server records the emotional state label, the probability vector, the user identifier, the timestamp, and the location in a user-emotion table.

The server functions as a group emotion index calculation unit. The server maps user locations to spatial areas using a geospatial indexing method, for example a grid mapping or geohash. The server retrieves, for each spatial area and for a given time window, all emotional state labels of users in that area. The server assigns numeric scores to each emotional category, for example 0 for normal, 1 for mild anxiety, 2 for strong anxiety, and 3 for panic tendency. The server computes an average score for the spatial area and the proportion of users whose emotional state is above a certain threshold. The server defines these values as group emotion indices and stores them in a block-emotion table associated with each spatial area.

The server functions as a composite risk evaluation unit. The server combines, for each spatial area, the disaster risk indicators and the group emotion indices into a composite risk value. In one embodiment, the server computes a weighted sum of a normalized physical risk score and a normalized group emotion score. In other embodiments, the server applies rule-based logic that increases composite risk when both physical risk and panic ratio exceed thresholds. The server stores composite risk values and risk categories such as low, medium, high, and critical for each spatial area.

The server functions as a guidance policy determination unit. The server retrieves, for a target user, the current emotional state from the user-emotion table and the composite risk, disaster risk indicators, and group emotion indices for the spatial area corresponding to the user's location. The server maintains a rule set that maps combinations of emotional state and composite risk to guidance policies. Each guidance policy specifies parameters such as desired text length, level of detail, necessity of explanation for route selection, tone (reassuring or urgent), and preferred presentation medium (individual device screen, audio output, or public display).

For example, the server selects a policy specifying short, concrete messages with simple sentences and no technical vocabulary when the emotional state is strong anxiety and composite risk is high. The server selects another policy specifying a more detailed explanation of route selection and hazard factors when the emotional state is close to normal.

The server functions as a prompt sentence generation unit. The server maintains a set of prompt templates in a text storage region. Each template contains parameter placeholders for hazard type, risk level, available routes, shelter characteristics, emotional state, output length, tone, and formatting constraints. The server selects a template based on disaster type and guidance policy and fills the placeholders with current values: for example, the name of an evacuation route, the risk category of the area, and the anxiety level. The server constructs a prompt sentence that includes a role instruction to the generative AI model, an output format specification (for example, numbered steps or bullet points), a character count constraint, and a tone specification. In one example, the server generates a prompt sentence of the following form:
“You are an assistant that generates disaster-time guidance messages for city residents.

The target user is currently in a state of strong anxiety and needs short and concrete instructions. In the area where the user is located, the building collapse risk due to an earthquake is medium, and the main evacuation route A is passable.

Generate a Japanese message that satisfies the following conditions:
Use a calm tone that gives a sense of reassurance.
Start with a sentence conveying ‘please stay calm’.
Show the nearest shelter that can be reached on foot and describe the route in 3 bullet steps.
Limit the total length to within 200 Japanese characters.”

In another example, the server generates a prompt sentence:
“You are an assistant that generates disaster-time guidance messages for city residents.

The target user can judge the situation relatively calmly.

In the area where the user is located, the building collapse risk due to an earthquake is high, and some roads are closed.

Generate a Japanese message that satisfies the following conditions:
Present an evacuation route and briefly explain why this route was selected (safety, low congestion).
Present two candidate nearby shelters and describe each one's characteristics (capacity, current congestion level) in one sentence.
Limit the total length to within 400 Japanese characters.”

For public display devices in a station, the server may generate a prompt sentence such as:
“You are an assistant that creates guidance texts for digital signage inside a train station.

Many people in this station are feeling anxious, and preventing panic is important.

Create a Japanese message in exactly 3 lines satisfying the following conditions:
1. Line 1: in at most 20 full-width characters, write a sentence conveying ‘the station is currently safe’.
2. Line 2: in short text that can be shown with an arrow, describe the nearest evacuation exit direction (east exit, west exit, etc.).
3. Line 3: in at most 20 full-width characters, write a sentence conveying ‘walk slowly without running’.

Output each line in at most 20 full-width characters, separated by newline characters.”

The server functions as a generative AI model execution unit. The server invokes a generative AI model, for example a large language model accessible as an external service or deployed on a dedicated machine, by sending the prompt sentence with configuration parameters such as maximum token count and temperature. The server uses an HTTP client library to transmit the prompt to the model's API endpoint and receives a response containing generated text. The server may perform validation such as checking text length and verifying that the output language matches the requested one. The server stores the generated text in a guidance-log table associated with the user and the prompt.

The server functions as a guidance information provision unit. The server constructs responses for terminals that include the generated natural language text and associated route data, such as a polyline representing coordinates between the user's current location and a shelter, and optional landmark descriptions. The server transmits this data to the terminal over a secure communication channel. For public display devices, the server sends the guidance text and layout parameters to a display control server, which renders the text on digital signage in the station or on roadside panels.

The server functions as a route display unit. The server attaches route data to the guidance information in a structured format. The terminal uses a map library to superimpose the evacuation route on a map display, marking the user's current position and the destination shelter. The association of text and route data ensures that instructions in the natural language text correspond to visible segments on the map.

The server functions as a resource distribution guidance unit. The server collects data about distribution points of emergency supplies, such as addresses, types of supplies, and operating times, from administrative or organizational sources. The server correlates this information with spatial areas and user locations and provides the closest distribution points as part of guidance information.

The server functions as a communication site guidance unit. The server aggregates network status information, such as base station availability and signal strength, and determines spatial areas where communication is relatively stable. The server supplies positions of such communication sites as part of guidance for users who need reliable connectivity.

The server functions as an infrastructure control unit. The server uses composite risk and group emotion indices to determine control actions for traffic control devices and public transportation control devices. For example, the server increases green signal durations on crossing points located along high-priority evacuation routes in spatial areas with high composite risk and high anxiety. The server sends structured control commands to traffic signal controllers via a traffic control network. The server also instructs public transportation operation controllers to dispatch additional vehicles, modify stopping patterns, or change headways for transport lines serving evacuation areas. This coordinated control is based on both physical risk (such as flood risk) and real-time crowd emotional state, and is not limited to static rules.

### C. Functional Configuration of the Terminal

The terminal executes the disaster-response application that implements data collection, feature extraction, and guidance presentation.

The terminal captures operation history information using event listeners in the user interface framework. The terminal records tap events, swipe events, and text inputs with timestamps and screen coordinates. The terminal computes derived features such as average tap interval over a moving time window, maximum swipe speed, and number of correction operations.

The terminal captures voice signals when the user presses a voice input button. The terminal uses the mobile operating system audio interface to sample the microphone at a predetermined frequency. The terminal divides the audio into frames, applies a short-time Fourier transform to obtain spectral features, and computes features such as energy, fundamental frequency, speech rate, and silence ratio. The terminal discards raw audio after computing features to reduce storage and protect privacy.

The terminal captures facial images using the front camera when the user grants permission. The terminal executes a lightweight facial expression model, for example an expression classifier implemented in a mobile-friendly neural network framework. The terminal detects a face region, normalizes the image, and obtains expression scores such as probabilities of anxiety, happiness, or neutrality. The terminal discards the raw image after computing the scores.

The terminal acquires location information and motion state via the operating system location service and motion sensors. The terminal estimates a motion state label such as stationary, walking, running, or in-vehicle based on sensor readings and location changes.

The terminal aggregates operation features, voice features, facial expression scores, location, and motion state into a feature record. The terminal serializes the feature record into a structured message, such as a text-based format, and transmits the message to the server over an encrypted connection. The terminal receives guidance information from the server, including natural language text and route data. The terminal displays the guidance text in a user interface, adjusts font size and color according to the user's emotional state, superimposes the route on a map using a map library, and optionally uses a text-to-speech function to read the guidance text aloud.

### D. Technical Effects and Improvement of Computer Technology

The server improves computer technology by reorganizing data processing, model execution, and control flows in a way that reduces computational waste and improves relevance of generated content. By estimating emotional states using a multimodal neural network on normalized feature vectors, the server reduces variance in feature distributions and improves classification accuracy relative to naive rule-based or single-modal models. As a result, the server more accurately classifies anxiety levels, which improves subsequent policy decisions.

The server improves computational efficiency by focusing generative AI calls on users and areas with higher composite risk or group anxiety. The composite risk evaluation unit identifies priority areas so that the server can allocate more processing resources and bandwidth to high-impact regions and reduce unnecessary generative AI calls in low-risk, low-anxiety areas. This selective calling reduces communication load with the generative AI model and reduces server load.

The server improves data management by using explicit data structures for user-emotion tables, block-risk tables, and block-emotion tables. The server maintains clear associations between sensor inputs, emotional outputs, and control actions. The combination of physical indicators and emotional indices yields a composite risk mapping that allows more granular server-side load balancing and priority scheduling.

The server uses generative AI models not as a mere replacement of human drafting, but as a controlled text generator whose behavior is regulated via structured prompt sentences that encode detailed constraints. The prompt sentence generation unit inserts explicit constraints on length, structure, and tone, and explicitly conditions the generative AI model on quantitative risk and emotion data. This interaction design with the model is not equivalent to simple free-form prompt usage; instead, it transforms internal risk and emotion signals into a machine-readable conditioning specification. The result is that the generative AI model behaves as a programmable text engine tightly integrated into the server's control logic, improving the determinism and precision of its outputs.

The server also achieves technical improvement in user interface control. By linking emotional state classifications to dynamic selection of font sizes, color schemes, and layout arrangements, the system optimizes visual load for different emotional conditions. People in strong anxiety receive simpler, high-contrast interfaces that reduce cognitive burden, while calm users receive more detailed information. This conditional UI rendering improves human-computer interaction efficiency compared with fixed layouts.

The system controls real-world devices such as traffic signals and public transport controllers using composite risk including crowd emotion, rather than using only traditional congestion metrics. By adjusting traffic signal timings based on combined hazard and anxiety information, the system can reduce crowding and slowdowns in areas where panic is likely, thereby decreasing the likelihood of dangerous bottlenecks. This coordinated control, driven by real-time crowd emotion measurements, is not simply automating a known human procedure; instead, it enables a new class of control strategies that a human operator could not reliably implement in real time due to the volume and complexity of data.

### E. Alternative Embodiments

The server may implement different neural network architectures for the emotional state estimation unit, such as recurrent neural networks when time-series correlations in features are important, or attention-based architectures to weigh different modalities dynamically. The server may use different loss functions, such as class-weighted cross-entropy, to cope with imbalanced emotional categories.

The server may locally host the generative AI model instead of using an external service. In such a case, the server loads the model parameters into GPU memory and performs generation by directly invoking the decoding algorithm, such as beam search or nucleus sampling, in the machine learning framework.

The terminal may execute a portion of the emotional state estimation locally, for example by running a simplified neural network model for coarse emotion classification and sending the preliminary label along with features to the server. This reduces server load and network traffic. The server may maintain different rule sets for guidance policy determination depending on disaster type or regional norms. The prompt templates may be dynamically adapted based on historical effectiveness metrics such as user response times or evacuation completion rates. The infrastructure control algorithms may be configured to balance evacuation priority and ordinary traffic flow, using feedback loops from sensor data indicating vehicle counts and crowd densities. By combining these components and variations, the system achieves a technical architecture in which server, terminal, and external devices operate in a coordinated fashion, using advanced data structures, neural network models, and control algorithms to improve the speed, accuracy, and stability of disaster-time guidance and infrastructure management relative to conventional systems.

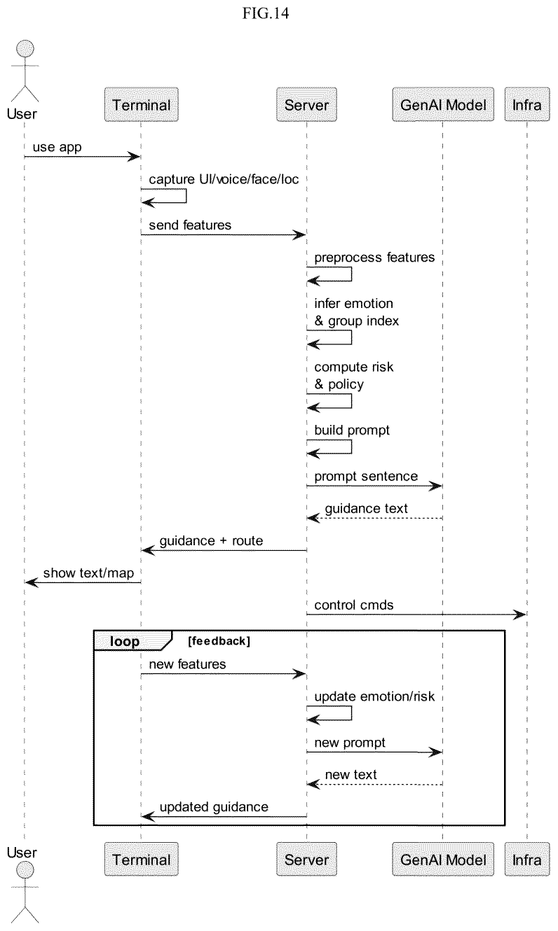

The following describes the processing flow using FIG. 14.

### Step 1:

The terminal initializes sensing and communication components.

The terminal starts the disaster-response application on the mobile operating system and requests permissions to access touch input, microphone, camera, location services, and motion sensors.

Input: Operating system resources and user permission settings.

The terminal, based on granted permissions, registers event listeners for touch input, configures the audio capture interface, opens the camera interface, and enables access to location and sensor APIs.

Output: An initialized application state in which the terminal is ready to capture user interactions, sensor data, and to communicate with the server.

### Step 2:

The terminal captures operation history information and computes interaction features.

The terminal records each tap, swipe, and text input event with timestamps, screen coordinates, and component identifiers.

Input: Raw UI events generated by user interactions.

The terminal groups events in time windows (for example, 30 seconds) and performs data processing to compute statistics, including average tap interval, taps per minute, maximum swipe speed, average swipe speed, and count of correction actions.

Output: An operation feature set containing numerical values representing interaction intensity, speed, and error tendency for the current time window.

### Step 3:

The terminal captures voice data and extracts voice feature information.

The terminal starts audio recording when the user presses a designated voice input control in the application.

Input: Continuous audio signal from the microphone.

The terminal samples the audio signal, segments it into overlapping frames, applies short-time Fourier transform to each frame, and calculates frame-level energy, fundamental frequency, and spectral features. The terminal then aggregates these values over the recording interval to compute average energy, average fundamental frequency, speech rate, and silence ratio.

Output: A voice feature set consisting of numerical descriptors of the user's speech characteristics without retaining the original waveform.

### Step 4:

The terminal captures facial images and computes facial expression feature information.

The terminal activates the front camera when camera use is allowed and captures face images at a reduced frame rate.

Input: Raw image frames from the front camera.

The terminal performs data processing by detecting a face region, normalizing the face image (crop, resize, normalize pixel values), and feeding the normalized image into a lightweight facial expression classification model. The terminal obtains probabilities for expression categories such as joy, anxiety, anger, sadness, and neutral, and discards the original image after inference.

Output: A facial expression feature set containing category probabilities or scores.

### Step 5:

The terminal determines location information and motion state information.

The terminal periodically queries the location service for latitude, longitude, and accuracy, and reads accelerometer and gyroscope measurements.

Input: Location readings and raw motion sensor readings.

The terminal calculates derived motion metrics such as acceleration magnitude and variance, and orientation changes over a short period. The terminal applies a classification rule or a small on-device model to categorize the motion state as stationary, walking, running, or in-vehicle.

Output: A location record including coordinates and a motion state label associated with the same time window as other features.

### Step 6:

The terminal builds a combined feature record and transmits it to the server.

The terminal aggregates the operation feature set, the voice feature set, the facial expression feature set, the location record, and the motion state label into a single structure, and attaches a user identifier and a timestamp.

Input: Operation features, voice features, facial expression features, location, motion state, user ID, and time information.

The terminal serializes this structure into a textual message, such as a JSON document, and sends it to a predefined server endpoint using an encrypted communication protocol.

Output: A transmitted feature message delivered to the server for further processing.

### Step 7:

The server receives the feature message and stores raw records.

The server, via its web application framework, accepts the incoming request from the terminal and parses the message body.

Input: Serialized feature message including user ID, timestamp, and feature sets.

The server extracts each field and performs data validation, such as checking for missing mandatory fields and verifying value ranges. The server writes the validated data into relational database tables dedicated to raw feature storage, associating the record with the user and time.

Output: A stored raw feature record that is available for preprocessing and model input.

### Step 8:

The server preprocesses features and prepares model input vectors.

The server retrieves normalization parameters for each feature dimension from configuration storage.

Input: Raw feature record from the database and normalization parameters.

The server maps each feature into a fixed position in a numerical vector, replaces missing values with default or imputed values, and applies normalization (for example, subtracting mean and dividing by standard deviation). The server packs the normalized values into a tensor object compatible with the machine learning framework.

Output: A normalized feature tensor ready to be input to the emotional state estimation model.

### Step 9:

The server estimates the user's emotional state using a multimodal neural network.

The server loads the parameters of the emotional state estimation neural network into GPU memory and executes an inference routine.

Input: Normalized feature tensor representing operation, voice, facial expression, and motion data for a user.

The server performs forward propagation through multiple layers, including modality-specific fully connected layers and shared fully connected layers, applies nonlinear activation functions, and computes an output vector of logits for emotional categories. The server converts the logits to probabilities using a softmax function and selects the category with the highest probability as the user's current emotional state.

Output: An emotional state label and a probability distribution across emotional categories associated with the user and timestamp.

### Step 10:

The server calculates group emotion indices per spatial area.

The server associates each user with a spatial area by mapping location coordinates to a spatial index.

Input: Emotional state labels and probabilities for multiple users, and their spatial indices.

The server assigns numeric scores to each emotional category and, for each spatial area and a specified time window, computes aggregate statistics, including average emotional score and the percentage of users with scores above a high-anxiety threshold. The server stores these aggregated values as group emotion indices in a block-emotion table.

Output: A set of group emotion indices per spatial area, representing collective emotional conditions.

### Step 11:

The server evaluates disaster risk indicators based on sensor and historical data.

The server retrieves sensor-derived statistical values for each spatial area and historical disaster records from the database.

Input: Aggregated observation statistics and historical disaster data.

The server applies a trained risk evaluation model, such as a regression or decision tree ensemble, to compute numeric risk scores for structural damage, flood, fire, and traffic disruption per spatial area. The server normalizes and stores these risk scores in a block-risk table.

Output: Disaster risk indicators for each spatial area that quantify physical hazard levels.

### Step 12:

The server computes composite risk for each spatial area.

The server reads the disaster risk indicators and group emotion indices for all spatial areas.

Input: Disaster risk indicators and group emotion indices per spatial area.

The server calculates a composite risk value for each spatial area using a predetermined combination method, such as a weighted sum of normalized physical risk and emotional risk scores, or rule-based escalation when both dimensions exceed thresholds. The server assigns risk levels (e.g., low, medium, high, critical) based on these composite values and persists the results.

Output: Composite risk scores and corresponding risk levels per spatial area.

### Step 13:

The server determines a guidance policy for a target user.

The server locates the target user's current spatial area using the user's latest location record.

Input: User's emotional state label, composite risk level for the user's spatial area, disaster risk indicators, and group emotion indices.

The server consults a stored rule set that maps combinations of emotional state and composite risk to guidance parameters such as message length, degree of detail, inclusion of reasoning, tone (reassuring or urgent), and preferred presentation medium. The server selects a specific guidance policy and records it as a policy instance tied to the user.

Output: A determined guidance policy that specifies how the system will generate and present guidance information to the user.

### Step 14:

The server generates a prompt sentence for a generative AI model.

The server selects a prompt template that matches the disaster type, guidance target (individual or public display), and policy parameters.

Input: Guidance policy, user's emotional state, disaster risk indicators for the area, group emotion indices, and template text.

The server performs text processing by inserting concrete values such as risk level descriptions, evacuation route identifiers, shelter characteristics, and character count limits into placeholder positions in the template. The server constructs a complete prompt sentence that includes role instructions to the generative AI model, output format requirements, length constraints, and tone specifications.

Output: A fully formed prompt sentence that encodes the desired behavior of the generative AI model for the current user and situation.

### Step 15:

The server obtains a natural language guidance text from the generative AI model.

The server sends the prompt sentence and configuration parameters to the generative AI model via an API call.

Input: Prompt sentence, model selection, maximum token count, temperature, and related parameters.

The server waits for the generative AI model's response, extracts the generated text from the response payload, and optionally performs post-processing such as trimming extra whitespace and verifying that the text respects length and language constraints. The server stores the generated text along with metadata in a guidance-log record.

Output: A natural language guidance text tailored to the user's emotional state and the current disaster context.

### Step 16:

The server prepares and transmits guidance information to the terminal and public displays.

The server retrieves route data that link the user's current location to one or more evacuation destinations.

Input: Generated guidance text, route data, and display settings.

The server composes a response for the terminal that includes the guidance text, route coordinates, and user interface hints such as recommended font size and color scheme. For public displays, the server creates display control messages containing the guidance text, target display IDs, and layout instructions. The server transmits these messages over secure network channels to the respective devices.

Output: Delivered guidance packets to terminals and public display control messages ready for rendering.

### Step 17:

The terminal presents the guidance to the user.

The terminal receives the guidance packet from the server and parses its contents.

Input: Guidance text, route coordinate data, and display hints.

The terminal uses a map rendering library to draw the evacuation route on a map centered around the user's current location, displays the guidance text in a panel using font size and colors that match the user's emotional state, and optionally invokes the text-to-speech engine to read the message aloud.

Output: A visual and/or auditory guidance presentation that the user can perceive and follow in real time.

### Step 18:

The server controls infrastructure devices based on composite risk and group emotion.

The server examines composite risk and group emotion indices for spatial areas along major evacuation routes.

Input: Composite risk scores, group emotion indices, and infrastructure topology data.

The server computes control decisions such as extending green light durations at selected intersections, prioritizing pedestrian signals on evacuation paths, and increasing the frequency of public transportation serving high-risk, high-anxiety areas. The server formats these decisions into compatible control commands and transmits them to traffic control devices and public transportation controllers.

Output: Applied control commands that adjust signal timings and public transportation operations to support safer and more efficient evacuations.

### Step 19:

The user acts on the guidance and generates new feedback data.

The user observes the guidance presented on the terminal or public displays and moves according to the suggested evacuation route and instructions.

Input: Visual and auditory guidance provided by the terminal and public displays.

The user's actions cause new interactions with the terminal, such as map checks and button presses, and produce updated location and motion data. The terminal captures these new events and sensor readings, computes updated feature sets, and sends them back to the server as in previous steps.

Output: Updated feature messages that allow the server to continuously re-estimate emotional states, recompute risks, regenerate prompt sentences, and adjust guidance and infrastructure control in an adaptive loop.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14.

Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

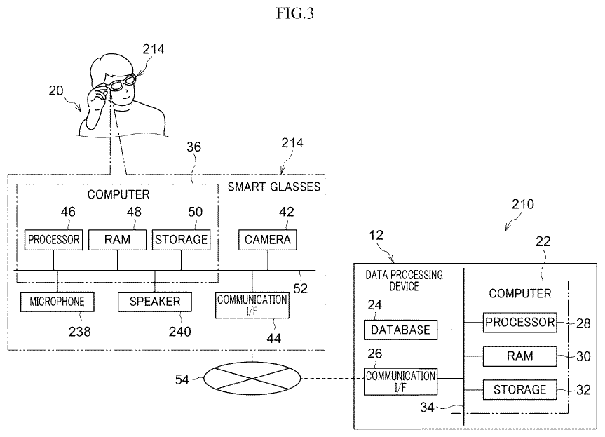

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

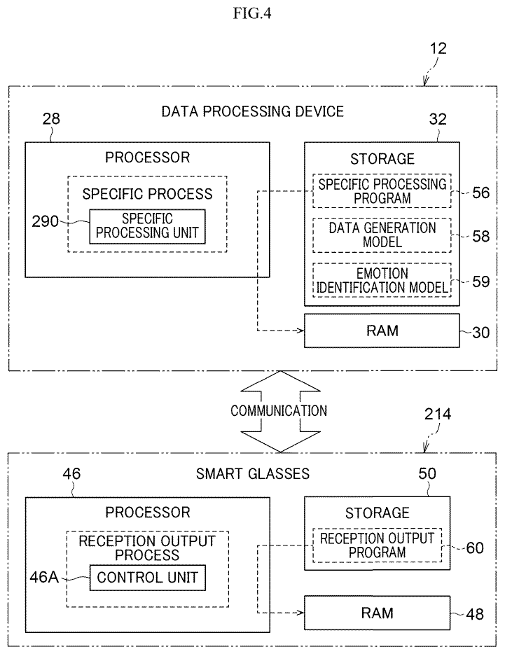

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

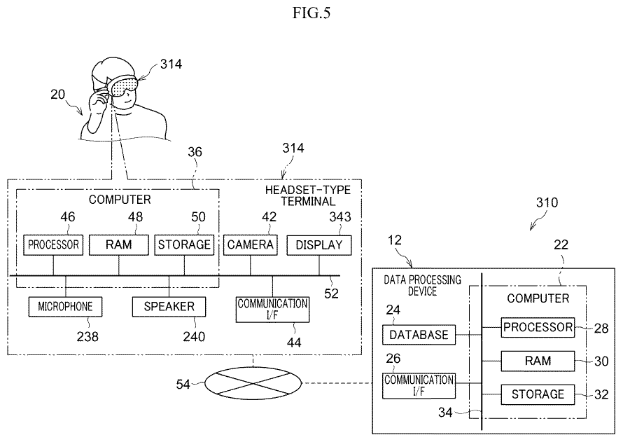

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

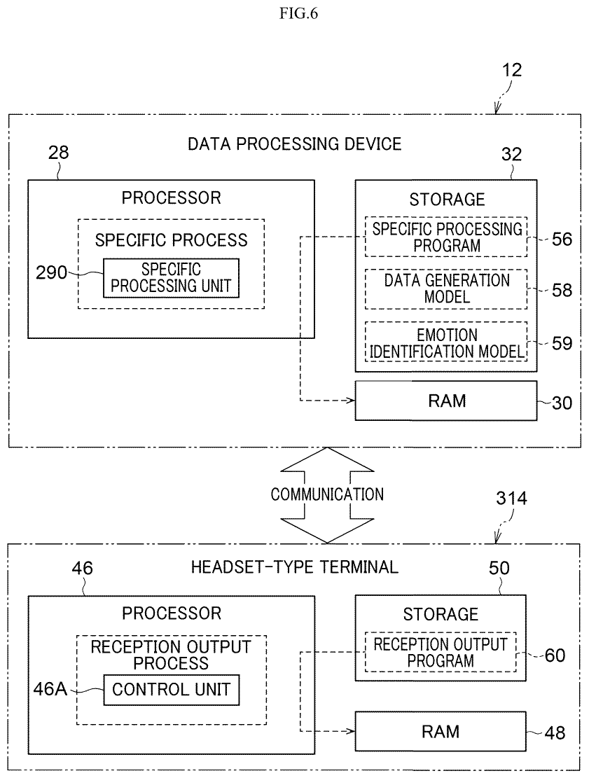

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user.

Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

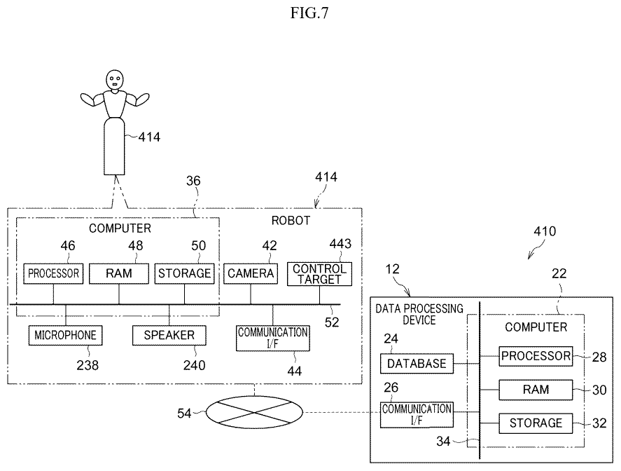

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

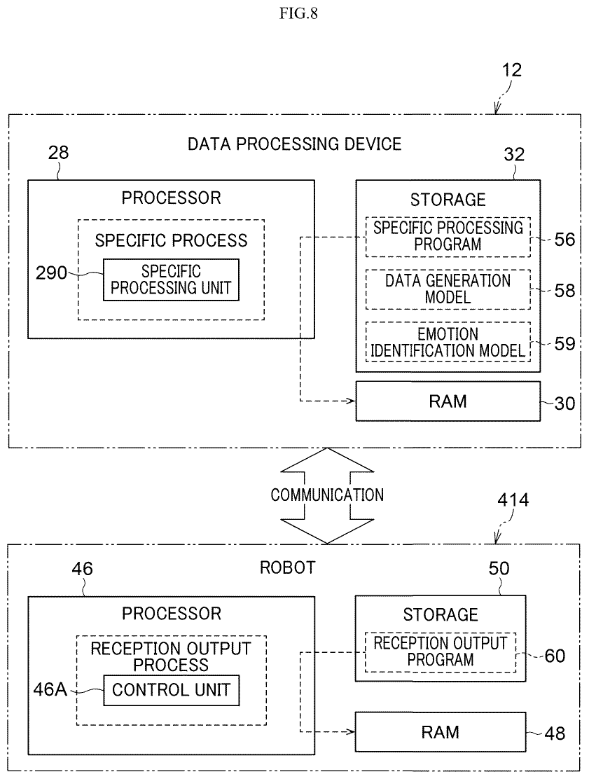

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

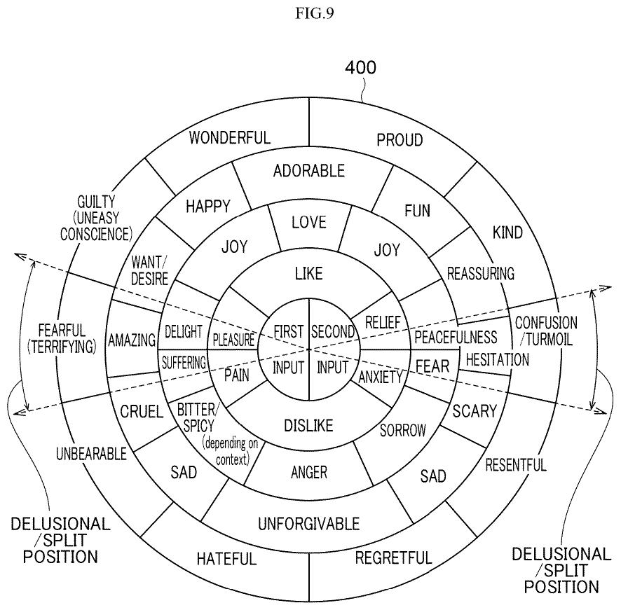

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

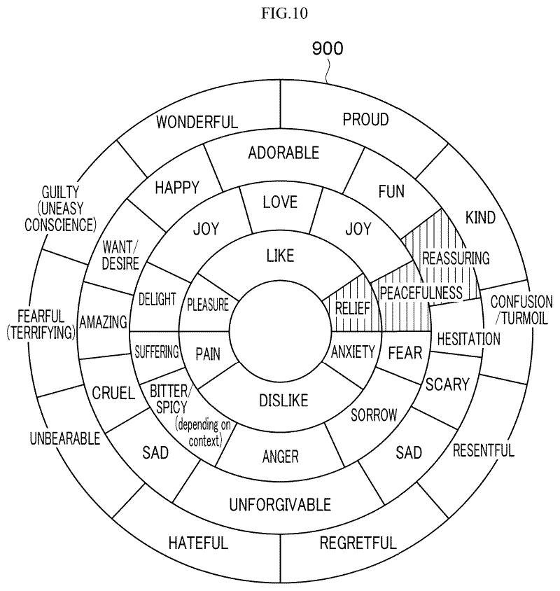

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
receive user attribute information and store the user attribute information as electronic data, and acquire environmental information relating to a disaster from an external information providing apparatus on the basis of location reference information and store the environmental information in a time-series manner, and
calculate a risk index for a residential area on the basis of the environmental information and the user attribute information, and
generate action guideline information according to the risk index and the user attribute information, and
distribute display information including the action guideline information, augmented reality display information, and map display information to a user terminal, and
control the user terminal to acquire a current position and a real-space image by using a positioning function and an imaging function, and to superimpose and display an evacuation route on the real-space image on the basis of the display information, and
collect and integrate relief distribution site information from an external information source, and calculate and present a distance and a required time from the current position to each relief distribution site, and
collect and integrate communication service providing site information from an external information source, and specify and present a position having a relatively good communication quality with respect to the current position, and
update the risk index and the action guideline information continuously on the basis of usage state information and the environmental information, and
generate a prompt sentence relating to an action guideline generation process in a disaster, input the prompt sentence to a generative AI model, obtain a candidate of the action guideline information from the generative AI model, select action guideline information that conforms to a safety criterion from the candidate, and reflect the selected action guideline information in the action guideline information.

### Supplementary 2

The system according to supplementary 1,
wherein the processor is configured to
treat the user attribute information as including age information, household composition information, and special support necessity information, and
calculate the risk index by calculating a plurality of stages of risk classification on the basis of vibration intensity information, damage occurrence frequency information, and past disaster history information included in the environmental information, and correcting the risk classification in accordance with the age information and the special support necessity information, and
present the relief distribution site information by evaluating, on the basis of the location reference information and the user attribute information, a movement required time, an assumed congestion level, and a type of supply for each relief distribution site and presenting the relief distribution site information to a user in order of priority, and
present the communication service providing site information by specifying a communication-available area on the basis of communication base equipment position information and communication quality information, and calculating and presenting a movement route and an estimated arrival time from the current position.

### Supplementary 3

The system according to supplementary 1,
wherein the processor is configured to
dynamically generate the prompt sentence by using context information including the risk index, the user attribute information, and the environmental information, and
verify the candidate of the action guideline information obtained from the generative AI model on the basis of a predetermined safety rule and a predetermined reliability rule, and remove or correct an instruction that conflicts with the safety rule or the reliability rule, and distribute the verified action guideline information to the user terminal, and
control a user interface of the user terminal such that, in accordance with contents of the action guideline information, at least one of evacuation route display, relief distribution site guidance, and communication service providing site guidance is preferentially displayed.

### Application Example 1

### Supplementary 1

A system comprising a processor,
wherein the processor is configured to
acquire user attribute information,
acquire regional disaster information and urban infrastructure information,
integrate and preprocess time-series data and image data obtained from observation devices and image acquisition devices,
calculate, for each spatial unit, a degree of risk associated with a plurality of types of disasters,
evaluate evacuation routes on the basis of shelter information and traffic flow information,
calculate an optimal evacuation route on the basis of a current position of a user and the user attribute information,
deliver the evacuation route and behavioral guidance to a user terminal and control display of the evacuation route and the behavioral guidance on the user terminal,
output, to an urban infrastructure control device, commands for signal control and operation control,
dynamically generate a prompt sentence to be input to a generative information processing model,
generate operator-oriented explanation information and general user-oriented guidance information on the basis of a response obtained from the generative information processing model, and
record an operation history including the prompt sentence and the response with respect to the generative information processing model and analyze the operation history to improve processing for calculating the evacuation route and processing for generating the prompt sentence.

### Supplementary 2

The system according to supplementary 1,
wherein the processor is configured to
acquire, as the user attribute information, age information, household composition information, and information on a user requiring special consideration, and
determine an individually optimized evacuation policy by taking into account constraint conditions including a means of movement, a moving speed, and staircase avoidance on the basis of the user attribute information when evaluating the evacuation route and when delivering and controlling display of the behavioral guidance.

### Supplementary 3

The system according to supplementary 1,
wherein the processor is configured to
acquire abstracted data indicating a disaster type, an assumed affected area, a shelter accommodation status, a traffic congestion status, and an infrastructure control status, generate the prompt sentence as an explanation request sentence, an operation plan request sentence, or a plain-language explanation request sentence including the abstracted data, and generate, on the basis of the response obtained from the generative information processing model, detailed operation plan information for an operator and simplified behavioral guidance information for a general user in a mutually distinguished manner.

### Example 2

### Supplementary 1

A system comprising a processor,
wherein the processor is configured to
receive user attribute information and location information via a user information input unit, acquire and store disaster-related regional information corresponding to the location information from an external information providing apparatus via a regional information acquisition unit,
extract features from at least one of voice information, image information, and operation history information of a user and estimate an emotional state of the user by applying a machine learning model to the features via an emotion recognition unit,
calculate a degree of risk to the user as a numerical value or a class on the basis of the disaster-related regional information acquired by the regional information acquisition unit, the user attribute information, and the emotional state estimated by the emotion recognition unit, and determine an information presentation mode on the basis of the degree of risk via a risk evaluation unit,
construct a prompt sentence to be input to a generative AI model on the basis of situation information including the degree of risk calculated by the risk evaluation unit, the information presentation mode, the user attribute information, and the disaster-related regional information, input the prompt sentence to the generative AI model, and acquire, from the generative AI model, at least one of an action guideline and guidance information relating to a user interface via a generative AI utilization unit,
control, on the basis of the action guideline acquired by the generative AI utilization unit, the information presentation mode determined by the risk evaluation unit, and the emotional state estimated by the emotion recognition unit, at least one of an amount of information and a display format including a number of display characters, a display layout, and presence or absence of audio output, and present the action guideline via an action guideline provision unit,
select an evacuation destination candidate on the basis of a current position of the user, the disaster-related regional information, and a result of the risk evaluation unit, calculate an evacuation route on the basis of road network information and hazardous location information, and present the evacuation route by at least one of a map display and an augmented reality display in accordance with the emotional state of the user and the information presentation mode via an evacuation route presentation unit,
acquire position information and distribution content information relating to a supply point, select at least one supply point on the basis of the current position of the user and the result of the risk evaluation unit, and present a position and distribution content of the at least one supply point via a supply point guidance unit,
acquire position information and communication quality information relating to a communication-possible point, select at least one communication-possible point on the basis of the current position of the user and the result of the risk evaluation unit, and present a position of the at least one communication-possible point via a communication point guidance unit, and analyze user behavior history information and transition information of the emotional state,
generate a prompt sentence including summary information based on the user behavior history information and the transition information of the emotional state, input the prompt sentence to the generative AI model, acquire proposal information from the generative AI model, and update at least one of a template of the action guideline and a user interface flow on the basis of the proposal information via a performance improvement unit.

### Supplementary 2

The system according to supplementary 1,
wherein the processor is configured to
cause the generative AI utilization unit, in a case where the degree of risk is high and the emotional state is evaluated as strong anxiety or panic, to include in the prompt sentence for the generative AI model constraint conditions that the generative AI model generate a concise action guideline by instructing the generative AI model to indicate only one action in a short sentence and to avoid use of technical terms,
cause the generative AI utilization unit, in a case where the degree of risk is low and the emotional state is evaluated as calm, to include in the prompt sentence constraint conditions that the generative AI model generate a detailed action guideline by instructing the generative AI model to include reasons for the action and a plurality of options, and
cause the action guideline provision unit to switch display content in accordance with the action guideline generated in compliance with the constraint conditions.

### Supplementary 3

The system according to supplementary 1,
wherein the processor is configured to
cause the evacuation route presentation unit, in a case where the emotional state of the user is evaluated as panic, to select only one evacuation route having a highest safety level on the basis of the result of the risk evaluation unit and the disaster-related regional information acquired by the regional information acquisition unit, and to present only the one evacuation route by superimposing a graphic indicating a traveling direction on a real-world image acquired from an imaging apparatus, and
cause the evacuation route presentation unit, in a case where the emotional state of the user is evaluated as calm, to simultaneously display a plurality of evacuation routes on a map display screen, to append at least a required time and a number of hazardous sections to each evacuation route, and to accept an operation for route selection from the user.

### Application Example 2

### Supplementary 1

A system comprising a processor,
wherein the processor is configured to function as a user information acquisition unit that acquires, from an information processing terminal, user attribute information, individual needs information, operation history information, voice feature information, facial expression feature information, location information, and motion state information,
wherein the processor is configured to function as a region information acquisition unit that acquires, based on geographical identification information, disaster-related information for a target area,
wherein the processor is configured to function as observation information processing unit that aggregates physical quantity data, image data, and video data acquired from a plurality of detection devices and image acquisition devices in association with time information and location information, and calculates statistical values for each spatial area,
wherein the processor is configured to function as a hazard evaluation unit that calculates, based on the disaster-related information and the statistical values, a disaster risk indicator for each spatial area,
wherein the processor is configured to function as an emotional state estimation unit that inputs the operation history information, the voice feature information, the facial expression feature information, the location information, and the motion state information into a machine learning model to estimate an emotional state of a user,
wherein the processor is configured to function as a group emotion index calculation unit that aggregates emotional states of a plurality of users belonging to a same spatial area based on the location information and calculates a group emotion index for each spatial area,
wherein the processor is configured to function as a composite risk evaluation unit that evaluates a composite risk for each spatial area by combining the disaster risk indicator and the group emotion index,
wherein the processor is configured to function as a guidance policy determination unit that determines, based on the emotional state of the user and the composite risk of a spatial area to which the user belongs, at least content, level of detail, expression format, and presentation medium of guidance information to be presented to the user or a group,
wherein the processor is configured to function as a prompt sentence generation unit that generates, by template processing, a prompt sentence for a generative AI model, the prompt sentence reflecting conditions determined by the guidance policy determination unit, the emotional state of the user, and the disaster risk indicator and the group emotion index of the spatial area,
wherein the processor is configured to function as a generative AI model execution unit that inputs the prompt sentence into the generative AI model and causes the generative AI model to generate a natural language text as the guidance information,
wherein the processor is configured to function as a guidance information provision unit that transmits the natural language text to a portable information processing device and a public display device to visually or audibly present the natural language text,
wherein the processor is configured to function as a route display unit that presents an evacuation route by superimposing route information associated with the natural language text on a map display,
wherein the processor is configured to function as a resource distribution guidance unit that presents positions of resource distribution points and information on provided resources based on aggregated spatial area information,
wherein the processor is configured to function as a communication site guidance unit that presents position information of sites where communication is relatively easy based on communication condition information, and
wherein the processor is configured to function as an infrastructure control unit that controls a traffic control device and a public transportation control device based on the composite risk and the group emotion index so as to adjust traffic flow and human flow along an evacuation route.

### Supplementary 2

The system according to supplementary 1,
wherein the processor is configured to cause the user information acquisition unit to acquire age information and family composition information of the user, to determine evacuation behavior and necessity of support according to an age class and a household composition, and to determine presence or absence of a member requiring special consideration,
wherein the processor is configured to cause the region information acquisition unit to acquire vibration information and meteorological information via a communication interface of a public information providing service and to acquire time-series disaster information from an administrative organization or an information distribution organization to grasp a damage situation,
wherein the processor is configured to cause the hazard evaluation unit to determine that a structural damage risk and a fire risk are high and to recommend immediate evacuation when a disaster scale exceeds a predetermined threshold,
wherein the processor is configured to cause the emotional state estimation unit to normalize a feature vector including operation features, voice features, and facial expression features extracted on the terminal, to input the normalized feature vector into a multi-input neural network, and to estimate one of a plurality of emotional categories including at least a normal state, a mild anxiety state, a strong anxiety state, and a confusion state, and wherein the processor is configured to cause the group emotion index calculation unit to assign a numerical score according to the emotional category and to calculate at least an average score of users in a spatial area and a proportion of users having high anxiety.

### Supplementary 3

The system according to supplementary 1,
wherein the processor is configured to cause the guidance policy determination unit to hold a set of rules that define, according to the emotional state of the user and the composite risk, at least an amount of text, a degree of concreteness, presence or absence of explanation of reasons, and a tone of the guidance information, to select short and concrete instructions with reassuring expressions when the emotional state indicates high anxiety, and to select detailed instructions including reasons for selection of an evacuation route and an outline of hazard factors when the emotional state is close to normal,
wherein the processor is configured to cause the prompt sentence generation unit to generate, based on the set of rules, the prompt sentence including at least a role instruction to the generative AI model, an output format specification, a character count constraint, and a tone specification,
wherein the processor is configured to cause the generative AI model execution unit to transmit the prompt sentence to an external or internal generative AI model and to obtain the natural language text,
wherein the processor is configured to cause the guidance information provision unit to present the natural language text while controlling, according to the emotional state of the user, at least a character size, a color scheme, a display layout, and presence or absence of voice reading, and
wherein the processor is configured to cause the infrastructure control unit to update signal control parameters and public transportation operation parameters based on the composite risk and the group emotion index.

What is claimed is:

1. A system comprising:
circuitry configured to:
receive, via a communication interface coupled to a packet-switched network, user attribute data and location reference data from a terminal device;
acquire environmental event data from one or more external data sources based on the location reference data and store the environmental event data as time-series data in a storage device;
calculate a risk index for a geographic area associated with the location reference data based on the environmental event data and the user attribute data;
generate a prompt data structure encoding the risk index, the user attribute data, and the environmental event data, transmit the prompt data structure to a generative neural network model, and receive guideline data from the generative neural network model;
verify the guideline data against predetermined safety and reliability rules stored in the storage device to produce verified guideline data; and
transmit display data including the verified guideline data, map data, and augmented reality overlay data to the terminal device via the communication interface.

2. The system according to claim 1, wherein the user attribute data includes at least age information, household composition information, and special requirement indicators, and wherein the location reference data includes at least one of a postal code and an address identifying a residential area of a user.

3. The system according to claim 2, wherein the circuitry identifies vulnerable household categories based on the household composition information including a presence of elderly persons or young children, and assigns priority classification data to the user attribute data stored in the storage device.

4. The system according to claim 3, wherein the circuitry acquires the environmental event data by transmitting requests to application programming interfaces of at least one of a meteorological data service and a regional information service, and by collecting real-time data from at least one of a governmental data source and a media data source via the packet-switched network.

5. The system according to claim 4, wherein the environmental event data includes seismic intensity values, structural damage assessments, and infrastructure status information, and wherein the circuitry stores the environmental event data as time-series records associated with geographic coordinates and timestamps.

6. The system according to claim 1, wherein the circuitry calculates the risk index by applying a weighted scoring model to the environmental event data including event magnitude, proximity to the geographic area, and infrastructure vulnerability factors derived from the location reference data.

7. The system according to claim 6, wherein the circuitry updates the risk index in response to changes in the environmental event data received from the one or more external data sources, and adjusts the risk index based on the user attribute data including age-based mobility factors and household composition factors.

8. The system according to claim 7, wherein the circuitry determines that the risk index exceeds a critical threshold when the environmental event data indicates a seismic intensity of a predetermined level or greater, and generates immediate evacuation recommendation data as part of the guideline data.

9. The system according to claim 1, wherein the generative neural network model comprises a transformer-based architecture with a plurality of self-attention layers, and wherein the prompt data structure further encodes action categories including infrastructure securing actions, evacuation necessity assessment, and resource location actions.

10. The system according to claim 9, wherein the circuitry verifies the guideline data by comparing each action item against the predetermined safety and reliability rules to confirm absence of contradictory instructions, presence of required safety warnings, and consistency with the risk index severity level.

11. The system according to claim 10, wherein the circuitry personalizes the verified guideline data based on the user attribute data by adjusting language complexity based on age information, including household-specific instructions based on household composition information, and prioritizing actions based on the special requirement indicators.

12. The system according to claim 1, wherein the augmented reality overlay data includes evacuation route data computed from a current position of the terminal device to a designated safe location, and wherein the terminal device superimposes the evacuation route data on a real-world image captured by an imaging sensor of the terminal device.

13. The system according to claim 12, wherein the circuitry calculates an optimal evacuation route by evaluating a plurality of candidate routes based on distance, estimated travel time, and infrastructure obstruction data derived from the environmental event data, and transmits turn-by-turn navigation overlay data to the terminal device.

14. The system according to claim 1, wherein the circuitry collects resource distribution site data from one or more external information sources, calculates for each site a distance and estimated travel time from the current position of the terminal device, and includes the resource distribution site data in the display data.

15. The system according to claim 14, wherein the circuitry further collects communication service availability data from network infrastructure data sources, identifies locations with operational communication services, and includes communication availability site data with distance and estimated signal quality in the display data.

16. The system according to claim 1, wherein the circuitry continuously monitors the environmental event data from the one or more external data sources at periodic intervals, recalculates the risk index upon detection of updated environmental event data, and transmits updated display data to the terminal device when the risk index changes by more than a predetermined delta.

17. The system according to claim 16, wherein the circuitry receives status confirmation data from the terminal device indicating a current safety status of the user, and adjusts the guideline data and the display data based on whether the user has reached a designated safe location or remains in transit.

18. A system comprising:
a communication interface including a network interface controller coupled to a packet-switched network and configured to transmit and receive data packets;
a memory storing instructions, a generative neural network model comprising a transformer architecture with a plurality of self-attention layers, predetermined safety and reliability rules, and time-series environmental event data; and
circuitry comprising one or more processors coupled to the memory and configured to execute the instructions to:
receive, via the communication interface, user attribute data and location reference data from a terminal device;
acquire environmental event data from one or more external data sources based on the location reference data;
calculate a risk index for a geographic area based on the environmental event data and the user attribute data;
generate a prompt data structure encoding the risk index and the user attribute data, transmit the prompt data structure to the generative neural network model, and receive guideline data;
verify the guideline data against the predetermined safety and reliability rules;
compute an evacuation route from a current position of the terminal device to a designated safe location;
collect resource distribution site data and communication availability data from external information sources; and
transmit display data including the verified guideline data, the evacuation route as augmented reality overlay data, and site guidance data to the terminal device via the communication interface.

19. The system according to claim 18, wherein the circuitry is further configured to continuously monitor the environmental event data, recalculate the risk index upon detection of updated data, and transmit updated display data to the terminal device when the risk index changes.

20. A method performed by circuitry of a server coupled to a packet-switched network via a communication interface, the method comprising:
receiving, via the communication interface, user attribute data and location reference data from a terminal device;
acquiring environmental event data from one or more external data sources based on the location reference data and storing the environmental event data as time-series data in a storage device;
calculating a risk index for a geographic area associated with the location reference data based on the environmental event data and the user attribute data;
generating a prompt data structure encoding the risk index, the user attribute data, and the environmental event data, transmitting the prompt data structure to a generative neural network model, and receiving guideline data from the generative neural network model;
verifying the guideline data against predetermined safety and reliability rules stored in the storage device to produce verified guideline data; and
transmitting display data including the verified guideline data, map data, and augmented reality overlay data to the terminal device via the communication interface.
